(19) United States
(12) Patent Application Publication
(10) Pub. No.: US 2013/0199571 A1
(43) Pub. Date: Aug. 8, 2013

(54) NOVEL THERMAL METHOD FOR RAPID COKE MEASUREMENT IN LIQUID ROCKET ENGINES

(71) Applicant: REACTION SYSTEMS, LLC, Golden, CO (US)

(72) Inventors: David Thomas Wickham, Boulder, CO (US); Bradley Dean Hitch, Golden, CO (US); Jeffrey Robert Engel, Golden, CO (US)

(73) Assignee: REACTION SYSTEMS, LLC, Golden, CO (US)

(21) Appl. No.: 13/675,786

(22) Filed: Nov. 13, 2012

Related U.S. Application Data
(60) Provisional application No. 61/628,914, filed on Nov. 10, 2011.

(51) Int. Cl. B08B 7/00

(52) U.S. Cl. CPC B08B 7/0071
USPC 134/19; 134/105

(57) ABSTRACT

There is disclosed a method of cleaning a liquid hydrocarbon-cooled bipropellant rocket engine. In an embodiment, method includes heating the engine to a temperature. The method includes applying ozone for a period of time. The method includes determining the temperature and the period of time are each sufficient to remove carbonaceous deposits. In another embodiment, the method may further include thermally imaging the heat transfer surfaces. There is disclosed apparatus for cleaning a liquid hydrocarbon-cooled bipropellant rocket engine. In one embodiment, the apparatus includes a heater, an ozone source, and a thermal camera. Other embodiments are also disclosed.

### REFERENCE TO PENDING PRIOR PATENT APPLICATION

This application claims the benefit under 35 U.S.C. 119 (e) of U.S. Provisional Patent Application No. 61/628,914, filed Nov. 10, 2011, by David Thomas Wickham, et al. for “A Novel Thermal Method for Rapid Coke Measurement in Liquid Rocket Engines,” which patent application is hereby incorporated herein by reference.

### GOVERNMENT LICENSE RIGHTS

This invention was made with government support under contract number FA9300-12-M-1008 awarded by the United States Air Force. The government has certain rights in the invention.

### BACKGROUND

Generally, carbonaceous deposits (“coke”) mapping and removal from liquid hydrocarbon-fueled rocket engines is not undertaken as current launch systems dispose of the rocket engines after a single use. The NASA Space Transportation System, referred to as the Space Shuttle program, employed reusable rocket engines for main propulsion. However, these reusable rocket engines burned liquid hydrogen as fuel instead of a liquid hydrocarbon. Since it is impossible to form coke from liquid hydrogen, coke formation in the engine liner cooling passages was never an issue for the Space Shuttle program. No truly reusable liquid hydrocarbon-fueled rocket engine has yet been developed, and no reusable rocket launch system using liquid hydrocarbon fuels currently exists.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided a method of cleaning a liquid hydrocarbon-cooled bipropellant rocket engine, the method comprising heating the engine to a given temperature; applying ozone to flow through channels in the engine wall for a period of time; and determining the given temperature and the period of time are each sufficient to remove carbonaceous deposits from heat transfer surfaces of the liquid hydrocarbon-cooled bipropellant rocket engine.

In another embodiment, there is provided a method of cleaning a liquid hydrocarbon-cooled bipropellant rocket engine, the method comprising heating the engine to a given temperature; applying ozone to flow through channels in the engine wall for a period of time; and thermally imaging the heat transfer surfaces to determine the given temperature and the period of time are each sufficient to remove carbonaceous deposits from heat transfer surfaces of the liquid hydrocarbon-cooled bipropellant rocket engine.

In yet another embodiment, there is provided apparatus for cleaning a liquid hydrocarbon-cooled bipropellant rocket engine, the apparatus comprising a heater configured to heat the engine to a given temperature; an ozone source configured to apply a flow of ozone to channels in the engine wall for a period of time; and a thermal camera configured to thermally image the heat transfer surfaces to determine the given temperature and the period of time are each sufficient to remove carbonaceous deposits from heat transfer surfaces of the liquid hydrocarbon-cooled bipropellant rocket engine.

In still another embodiment, there is provided a method of cleaning a liquid hydrocarbon-cooled bipropellant rocket engine, the method comprising heating the engine to a given temperature; applying ozone to flow through channels in the engine wall for a period of time; and monitoring at least one of carbon dioxide and water emitted from the channels to determine the period of time are each sufficient to remove carbonaceous deposits from heat transfer surfaces of the liquid hydrocarbon-cooled bipropellant rocket engine.

In another embodiment, there is provided a method of cleaning a liquid hydrocarbon-cooled bipropellant rocket engine, the method comprising heating the engine to a given temperature; applying ozone to flow through channels in the engine wall for a period of time; and monitoring infrared thermal imaging of the engine to determine the period of time are each sufficient to remove carbonaceous deposits from heat transfer surfaces of the liquid hydrocarbon-cooled bipropellant rocket engine.

In yet another embodiment, there is provided apparatus for cleaning a liquid hydrocarbon-cooled bipropellant rocket engine, the apparatus comprising a heater configured to heat the engine to a given temperature; and an ozone source configured to apply a flow of ozone to channels in the engine wall for a period of time.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates the effect of coke layer thickness on the liner temperature rise at a heat flux of 100 Btu/in²-sec. (16.3 kW/cm².)

FIG. 2 is a schematic illustration of copper area that may be affected by coke oxidation exothermic reaction in a single cooling channel.

FIG. 3 is a schematic illustration of a laboratory coke mapping test rig.

FIG. 4 illustrates an exemplary set up of the laboratory coke mapping test rig of FIG. 3.

FIGS. 5A and 5B illustrate measured transient CO₂ concentration and transient ¼″ copper tube wall temperatures during a decoking run.

FIGS. 6A-6C illustrate measured tubular test section transient temperatures for the initial decoking run in FIG. 6A, a blank (i.e., repeat) run in FIG. 6B, and FIG. 6C illustrates coke oxidation data after subtracting baseline data for a copper tube painted with graphite paint.

FIGS. 7A and 7B illustrate subtracted transient temperature differences for two runs with graphite paint applied to both ends of the test section.

FIG. 8 illustrates drawing and pre-brazing of the multichannel plate test section.

FIG. 9 illustrates a multi-channel plate test section mounted on the test apparatus.

FIGS. 10A-100 illustrate a surface temperature differences between the oxidation and baseline runs during a test with the multi-channel plate (MCP): 8 seconds before the O₃ flow was started, 142 second after O₃ start, 172 seconds after O₃ start.

FIGS. 11A-11C illustrate temperature differences measured on the face of the MCP eight seconds before the O₃ flow was started, and at 142 seconds after O₃ was started and 192 seconds after O₃ was started, using graphite paint as the source of carbon.

FIGS. 12A-12C illustrate temperature differences between the first and second baseline runs measured on the multichannel plate after the carbon had been oxidized.

FIGS. 13A-13C illustrate temperature differences measured on the multichannel plate before O₃ flow was started, at 142 seconds after O₃ was started and 192 seconds after O₃ was started for the first run with RP-2.

FIG. 14 illustrates exemplary geometry of a regeneratively cooled thrust chamber and nozzle used for the engine heating analysis.

FIG. 15 illustrates a regeneratively cooled rocket engine thrust chamber and nozzle with an outer heating mantle/insulating jacket and internal convective heater/propane burner.

FIG. 16 illustrates engine temperature versus time during an ozone decoking and thermal imaging cycle.

FIGS. 17 and 18 illustrate typical rocket engines.

FIG. 19 illustrates fuel cooling channels machined in the rocket engine walls.

FIG. 20 illustrates an embodiment of cleansing ozone flow through a rocket engine.

FIG. 21 illustrates an embodiment of an electrical heating mantle and insulating jacket on the outside of a rocket engine.

FIG. 22 illustrates heat low from a propane burner through the rocket engine within the heating jacket illustrated in FIG. 21.

FIG. 23 illustrates an arrangement of a camera and a mirror for thermal imaging.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

In an embodiment, there is provided a system and a procedure for the identification and simultaneous removal of carbonaceous deposits (“coke”) on heat transfer surfaces of liquid hydrocarbon-cooled bipropellant rocket engines. This technique involves a dilute mixture of ozone in oxygen and an inert gas, such as nitrogen. After warming the rocket thrust chamber and other fuel-cooled hardware to a temperature between 100 and 200° C., flowing this dilute ozone mixture through the engine liner cooling channels allows oxidation of the surface-adhered carbonaceous material to CO₂ and water. In various embodiments, the ratio of ozone and oxygen to one or more inert gasses may include a wide range of percentages. Furthermore, ozone and oxygen may be applied to a rocket engine with or without other gasses, including inert gasses. This gentle, low temperature oxidation process releases heat that is conducted into the underlying metal (which is generally copper), allowing visualization of the areas where oxidation is taking place by monitoring the inner surface of the liner using a thermal imaging camera. Even though the diffusion of heat within the liner tends to smear out the heat release location, a high sensitivity thermal camera can still localize the area of heat release by observing temperature changes and differences on the order of 0.1° K. The removal of this thin layer of carbonaceous material (typically on the order of 1 to 2×10⁻⁶ inches thick) after each run allows the reuse of liquid hydrocarbon-fueled rocket engines by preventing the buildup of insulating coke layers from run to run. Coke has a much lower thermal conductivity than copper and thicknesses of only several millionths of an inch (e.g., about 0.0254 microns to about 0.0762 microns) can cause the wall temperatures to reach levels where they will fail causing loss of coolant which can also overheat the channel downstream of the leak, potentially causing skewed temperature profiles, low thrust performance, an early engine shutdown, or even complete engine failure. Knowing the location of coke deposits is helpful in that the quantity and location constitute information about the health of the engine and allows the operator to track changes in performance to estimate the remaining service life of the engine.

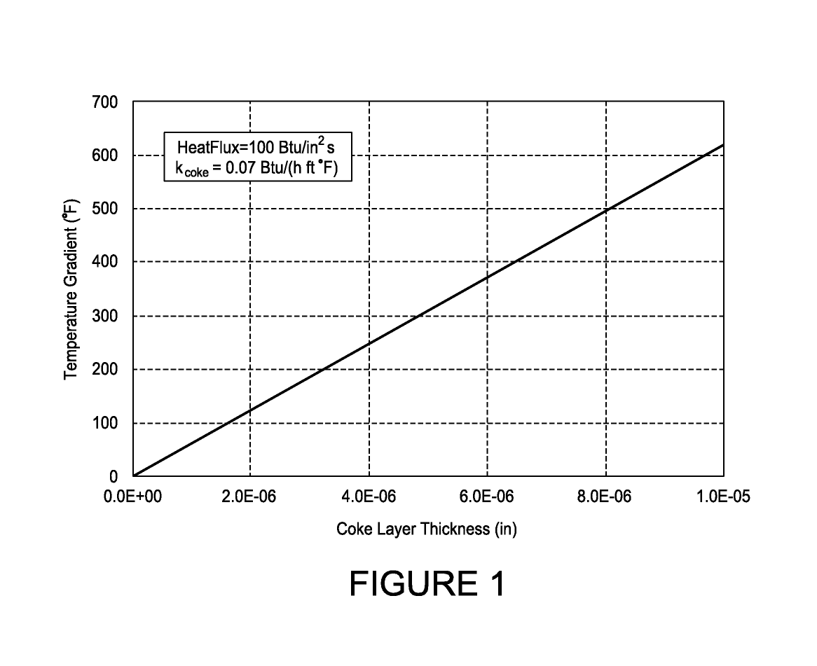

Carbon deposition in rocket engine cooling channels is potentially a very serious problem because current estimates suggest that coke has a thermal conductivity of only about 0.07 Btu/h-ft-° F. (0.12 W/m-C°) (approximately 3000 times lower than the copper of the thrust chamber walls.) (Edwards, J. T., “Liquid Fuels and Propellants for Aerospace Propulsion: 1903-2003”, AIAA Journal of Propulsion and Power, 19(6), 1089-1107 (2003)) The accumulation of even very thin layers of coke can cause the walls to reach temperatures where they will fail. FIG. 1 shows the temperature gradient (i.e., difference) developed across a carbon layer with a heat flux of 100 Btu/in²-sec (16.3 kilowatts/cm²-sec) as a function of thickness. Since the coating is formed on the inside of the fuel flow path, between the heat source and the fuel, this temperature difference is the resulting increase in the liner wall temperature. At a thickness of two millionths of an inch (50 nanometers) the temperature gradient would be in the range of 120° F. (49° C.), and at a thickness of four millionths of an inch (100 nanometers) it would increase to 250° F. (121° C.). Such an increase is likely to approach or exceed the temperature and structural limits of the liner. Therefore, even if the carbon deposited in each mission is low, it is likely that over multiple flights enough coke would accumulate to cause a serious problem.

The location and thickness of coke layers deposited in copper test sections may be characterized by monitoring the outer surface temperature of a test article with a thermal imaging camera while the coke inside the test section is oxidized at low temperature to CO₂ using a mixture of O₃ in O₂ and N₂. The oxidation of coke with O₃ produces 161 kcal of thermal energy for every gram mole of carbon oxidized:

C+2O₃→CO₂+2O₂ ΔH=−162 kcal/gmol C Eq. 1

For example, it may be assumed that the coke layer is deposited on the three sides of the channel where the temperatures are hottest, i.e., the surface next to the hot gas of the thrust chamber and the two side walls of the channel, and that the channel width is 0.127 cm (0.050″) and the height is 0.381 cm (0.150″). The total surface area of the three sides in a one cm length is 0.889 cm². If the coke layer is 2.54×10⁻⁶ cm (1.0×10⁻⁶ inches) thick, the total quantity of carbon present is 2.26×10⁻⁶ cm³. Using a coke density (Hazlett, R. N., “Oxidation Stability of Aviation Turbine Fuels,” ASTM, Philadelphia, Pa., (1991)) of 1.0 g/cm³, the deposit weight is 2.26×10⁻⁶ g, which is equivalent to 1.88×10⁻⁷ gram-moles of carbon. With the above heat of reaction, that quantity of coke would produce an exotherm of 0.031 calories or 0.128 joules when oxidized.

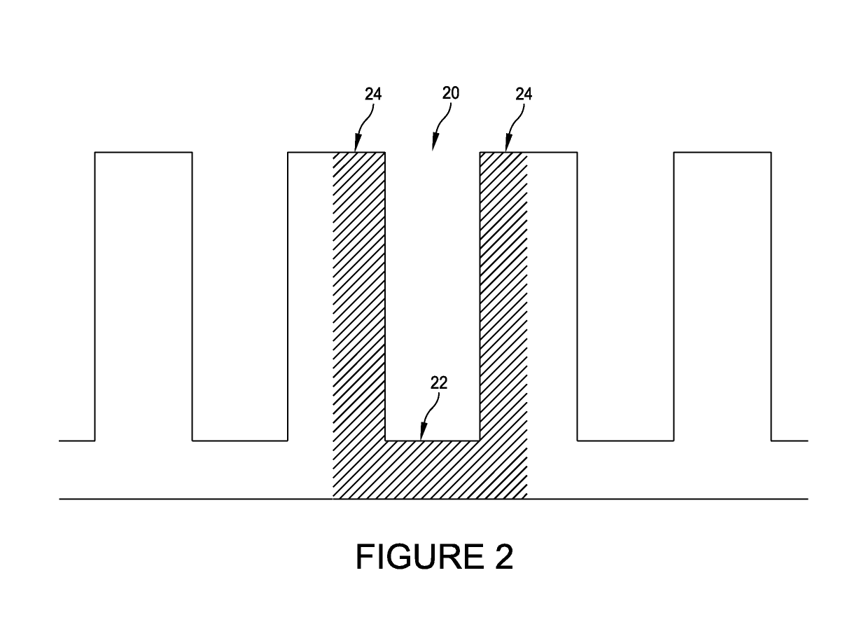

The magnitude of the temperature change produced in the length of the channel depends on the quantity of copper that bounds the three sides. FIG. 2 shows a schematic illustration of the copper area 20 affected by the temperature change. Included in this quantity is the copper metal 20 immediately beneath each channel 22 and half of each intervening land 24. Therefore for the dimensions given in FIG. 2, the total volume of copper heated by the oxidation of coke in a one cm length of cooling channel is 0.071 cm³. Using a copper density of 8.9 g/cm³, that volume is equivalent to 0.632 grams of copper. The heat capacity of copper in this temperature range (Incropera, F. P. and DeWitt, D. P., “Fundamentals of Heat and Mass Transfer,”4^{th} ed., John Wiley & Sons, New York (1996)) is 0.40 J/g-K, resulting in a maximum copper temperature rise of 0.51° C. Fortunately, this temperature rise is more than adequate to be detected by commercially available thermal imaging cameras. For example, the FLIR SC325 microbolometer array thermal imaging camera has a Noise Equivalent Temperature Difference (NETD) detection limit of 0.05° C., which is ten times lower than the temperature increase predicted for oxidizing a coke layer one millionth of an inch thick. We could therefore conceivably detect coke layers down to a thickness of 0.1×10⁻⁶ inches thick (2.54 nanometers). A coke layer of this thickness increases the operating temperature of the copper liner by only 3.5° C. at the 100 Btu/in²-sec (16.3 kW/cm².) heat flux level shown in FIG. 1.

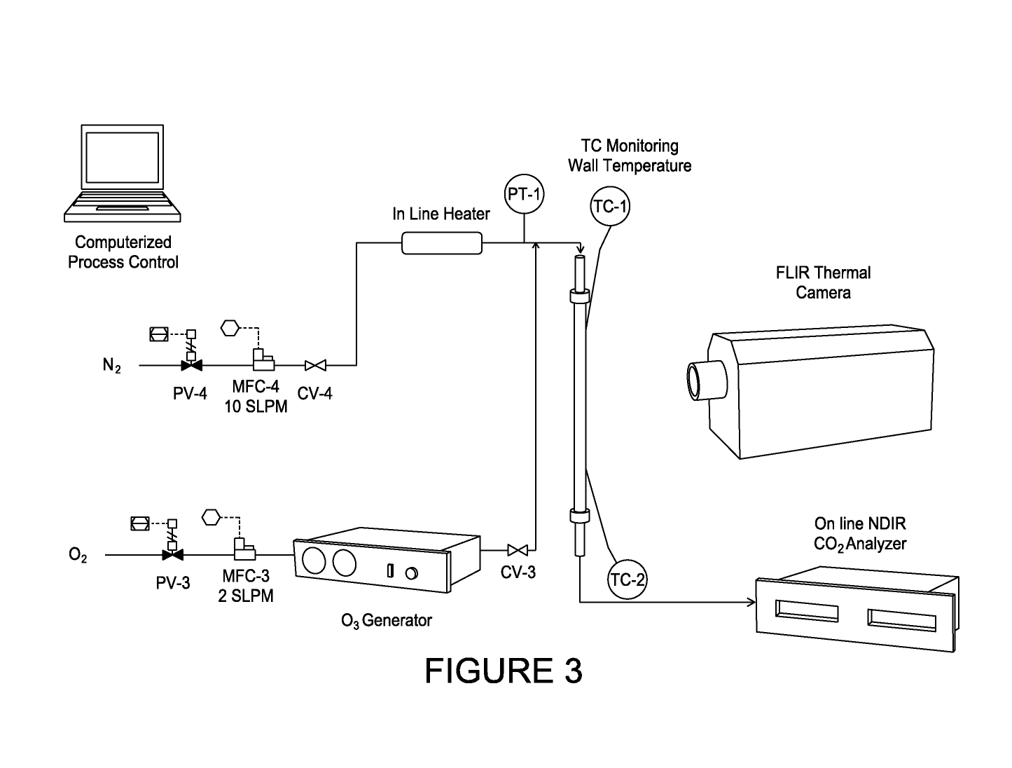

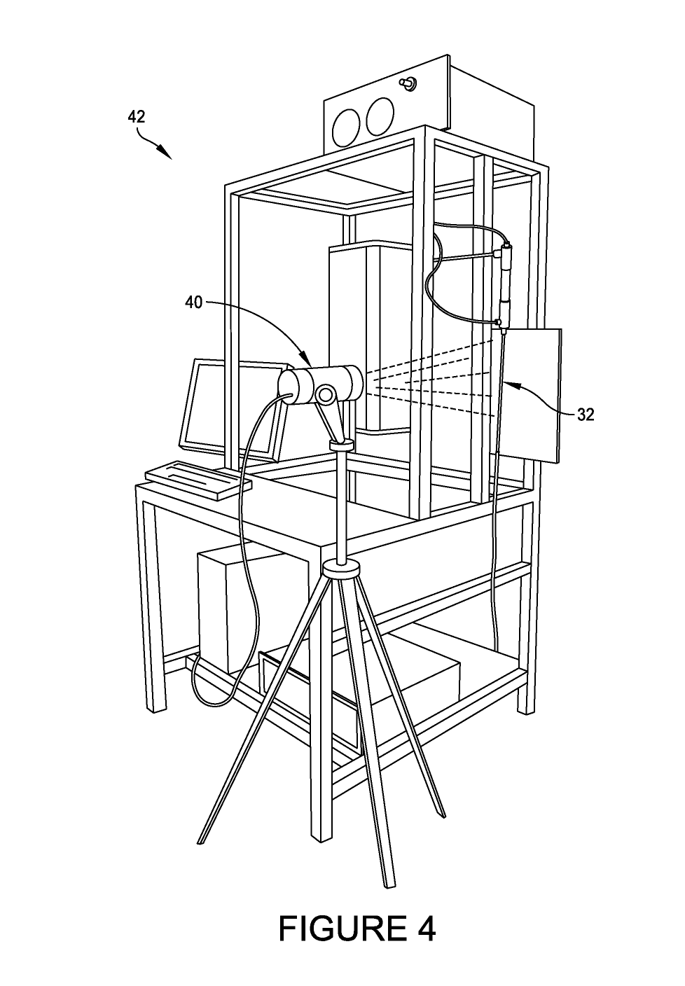

An illustration of a test apparatus 30 used to conduct experiments is shown in FIG. 3. A manifold (not shown) fit with mass flow controllers (not shown) generates the mixture of N₂ and O₂ for introduction a coked tube 32. An inline cartridge heater 34 was used to heat the N₂ flow and raise the temperature of the mixture and test section to temperatures for oxidation reaction. The O₂ flow passed through the TG-10 Ozone generator 36, which produces O₃ concentrations from less than 0.5 percent (by weight) up to 10 percent (by weight). Although O₂ always was directed through the O₃ generator, O₃ was only produced when the generator power was turned on. Finally, the flow exiting the tube passed through a California Analytical non-dispersive infrared (NDIR) Model ZRE CO₂ analyzer 38, which monitored CO₂ concentrations down to 10 ppm. The surface of the ¼″ copper tube test section 32 included high temperature flat black paint to maximize its surface emissivity and the accuracy of the surface temperature measured with a FLIR SC325 camera 40. For these tests, the thermal camera 40 positioned 20 inches away from the tube 32 so as to cover the full 8-in length of the test section. An illustration 42 of the test apparatus 30 with a copper tube test section 32 installed is shown in FIG. 4.

Three processes were used to apply a layer of carbon to the internal surface of the copper test articles; The first process simply trapped a small sample of JP-7 fuel in the test section, which was placed in a muffle furnace at 400 to 450° C. for several hours. While simple, this method did not allow a uniform control or location of the coke deposits. The second process was used graphite paint as the composition was known an control of deposition occurred. Importantly, it is unknown as to the differences in ozone reactivity or graphite paint compared to coke. The third process included thermally cracking flowing n-dodecane or RP-2 fuel at high temperature and pressure. This method allowed deposition of coke in a manner more like the actual rocket engine coke deposits. The deposits could not be controlled for location of information or uniformity. Also, in early tests the copper tube was simply insulated on the back side and not heated independently. As a result, the temperature of the test section decreased from inlet to exit due to the transfer of heat to the ambient surroundings.

Phase I Test Results

Tubular Test Section

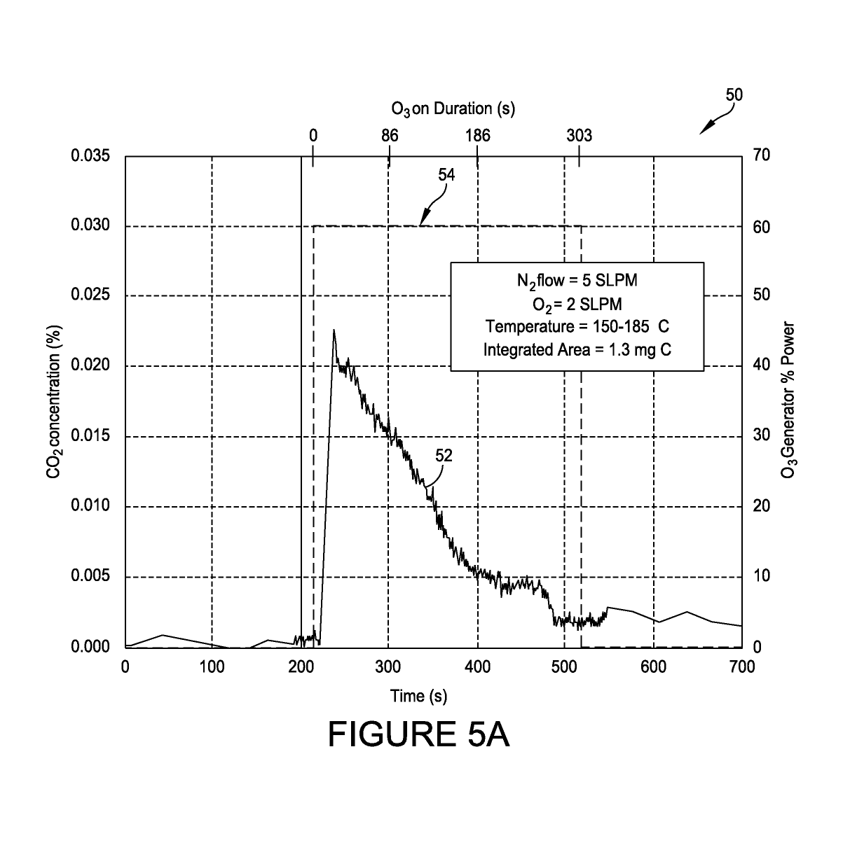

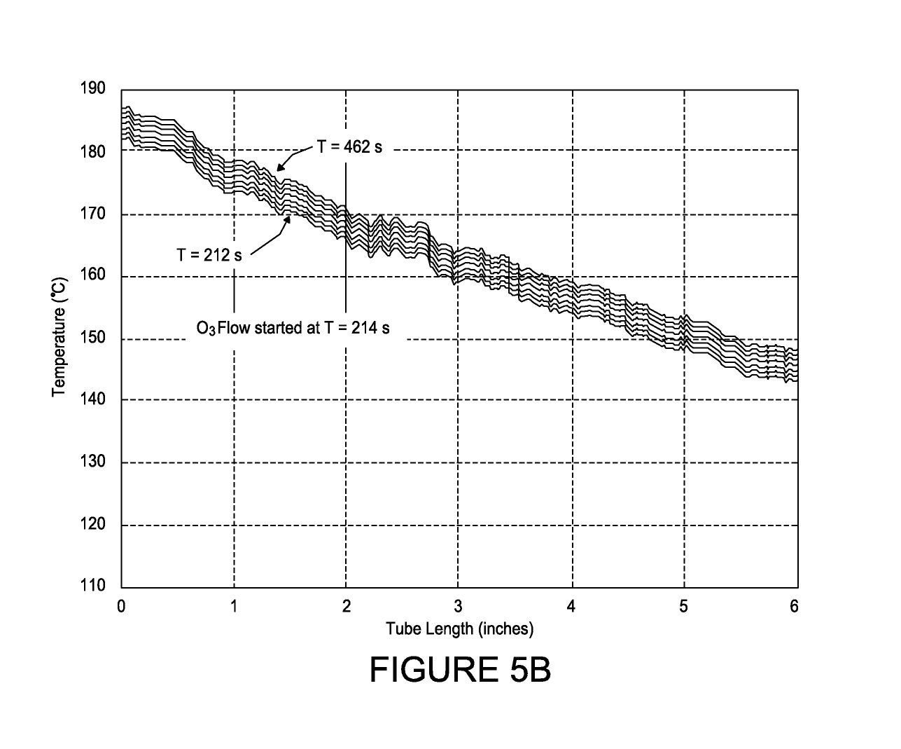

These factors explain the data of graph 50 shown in FIG. 5A, measured during an early decoking run. The left graph 52 shows how the transient CO₂ concentration rises rapidly after turning on the ozone generator then falls slowly over the course of the test, while the right graph 54 shows the test section surface temperature distributions measured at different times. Integration of the CO₂ peak yielded an estimated total coke deposit of 1.3 milligrams of carbon, which corresponds to an average coke thickness of 10.4 microinches (0.26 micrometers.) Test section surface temperatures gradually increased by up to 5° C. over the course of the coke removal run. Referring now to FIG. 5B, the top profile was acquired at a run time of 462 seconds, 56 seconds before the power to the O₃ generator was shut off. Only included are the temperature profiles that are increasing with time for clarity in this figure, however temperature measurements made after 462 seconds began to decrease even though the O₃ generator was still activated. This occurred because nearly all of the coke had been oxidized at this point so heat from coke oxidation was greatly reduced or no longer being generated. Based on the observed coke mass of 1.3 milligrams and a copper test section mass of 19.2 grams of copper it can be estimated that the ideal temperature rise of the test section would have been 9.6° C. if all of the heat released from carbon oxidation had been deposited in the tube wall. This suggests that approximately half of the heat released during coke oxidation was lost to the surroundings, to the internal gas flow or both.

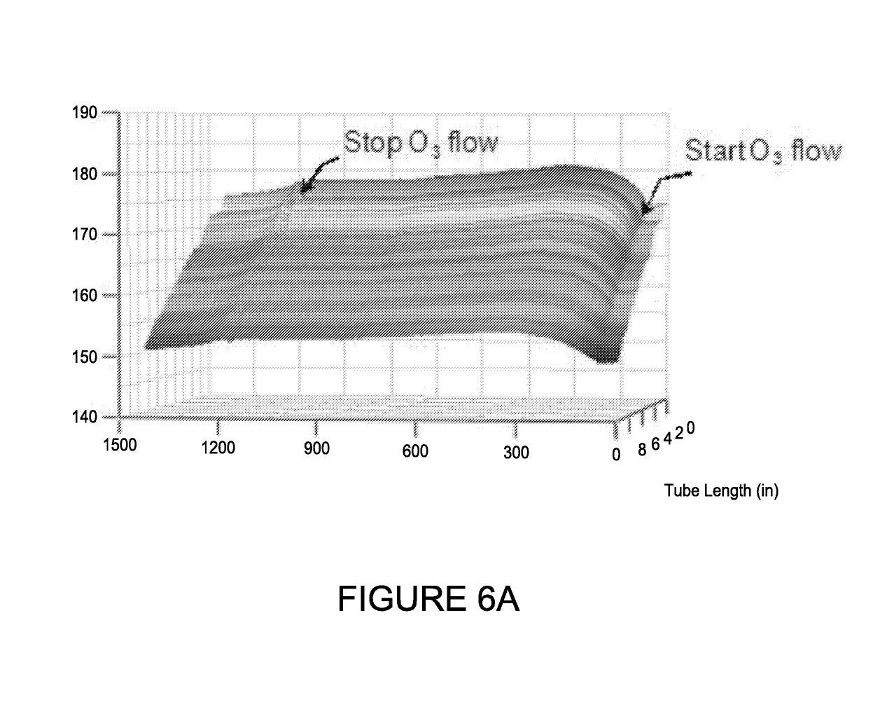

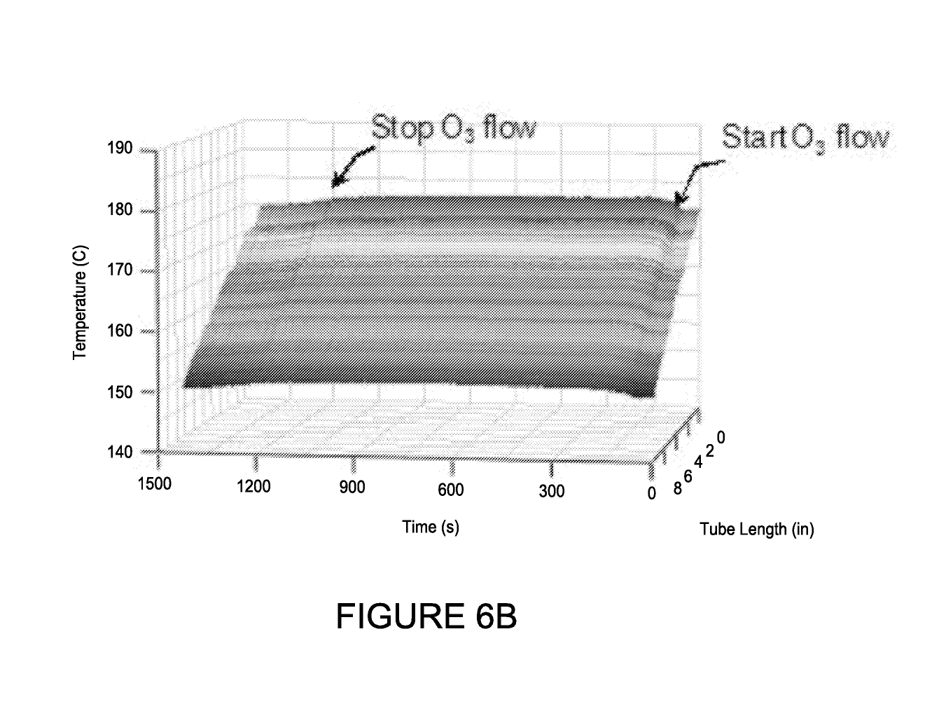

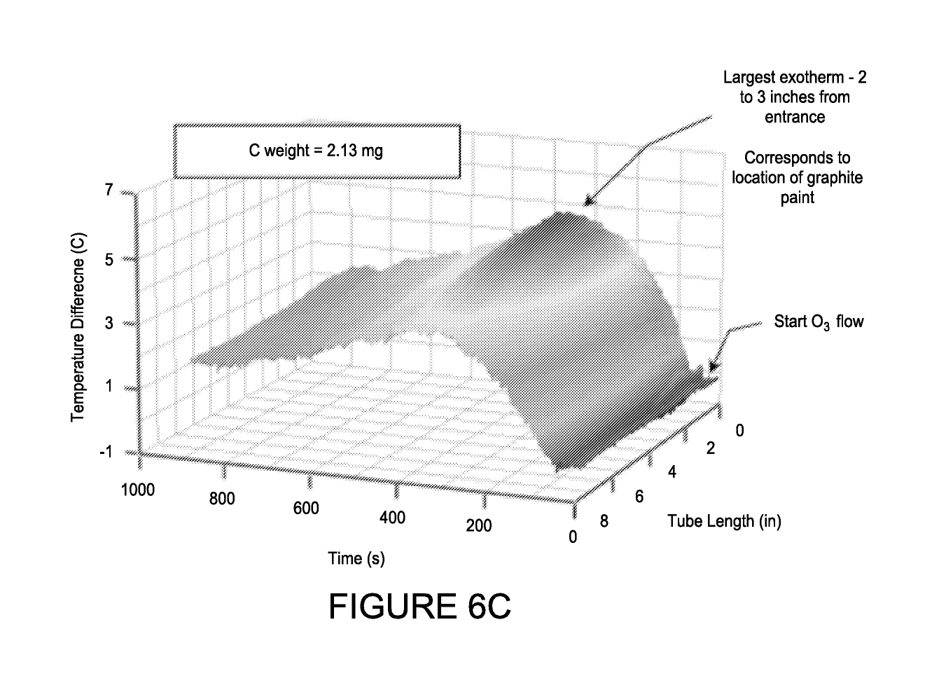

Since the ozone generation process is not 100% efficient, turning on the O₃ generator also results in some heating of the O₂ flow. This shows up as an additional transient temperature effect during decoking. In order to eliminate this effect, the procedure may be changed to repeat the run after a decoking cycle to obtain a blank, allowing elimination of the effect of the O₃ generator heating by subtraction. This process is shown in FIGS. 6A-6C. FIG. 6A shows a plot of the measured test section transient surface temperatures over the course of the decoking run. FIG. 6B shows a plot of the measured transient surface temperatures during the repeat of the ozone decoking run. FIG. 6C shows the result of subtracting the plot of FIG. 6B from the plot of FIG. 6A. Subtracting the blank run shows the location of the carbon (in this case graphite paint located approximately 2.5″ down the test section) much more clearly than the raw temperature plots of FIG. 6A or FIG. 6B.

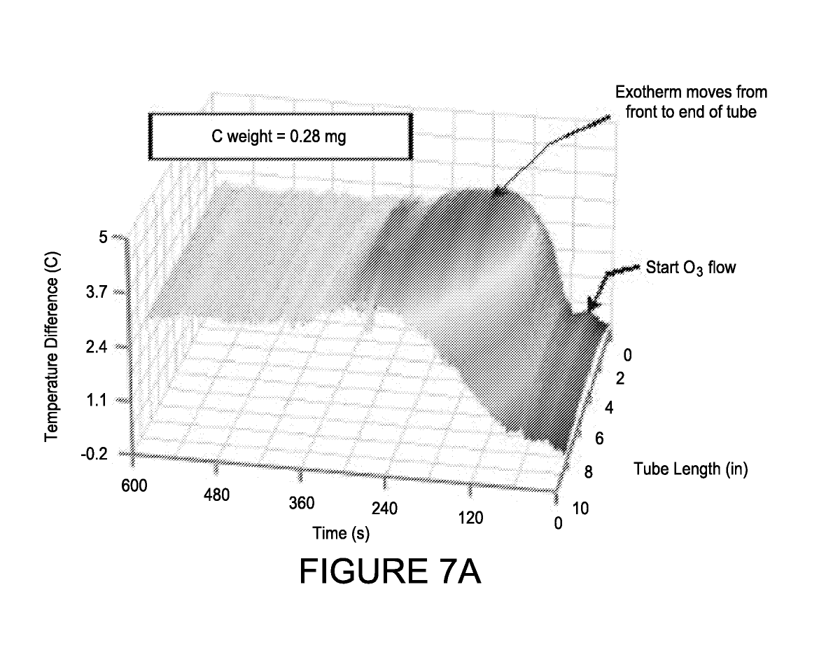

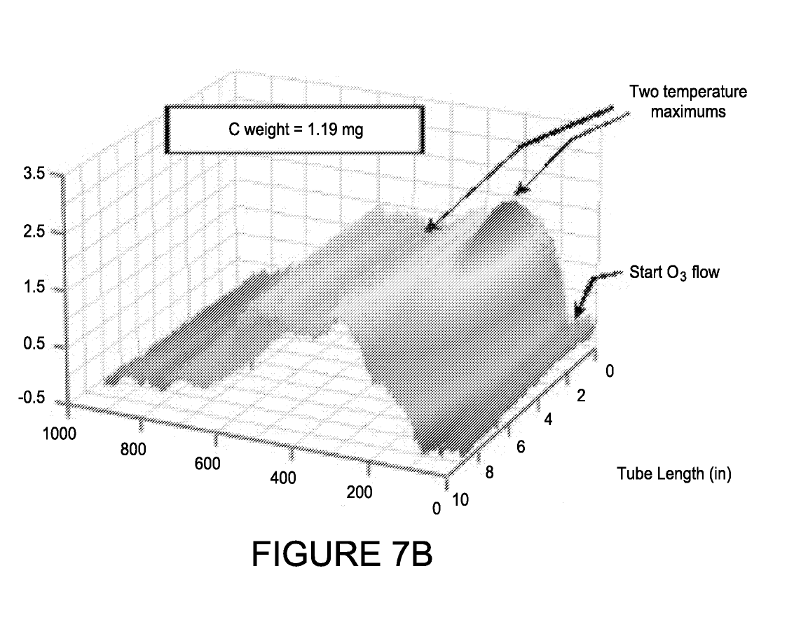

Additional tests were also carried out with the graphite paint. Less overall carbon was applied and the paint was also added to both ends of the tubes in order to verify that the method has the potential to resolve the position of coke deposits down the length of the tube. The results of these tests are presented in FIGS. 7A and 7B (in this case, there are shown only the temperature differences). When the O₃ addition begins, the temperature rises most rapidly at the front end of the tube, reaching a maximum at approximately 180 seconds. In addition, FIG. 7A shows that the temperature at the tube exit (seven inches down the length) reaches a similar maximum temperature, but that it occurs approximately 60 seconds after the front end temperature peak. Therefore, there are two substantial differences between the data presented in this figure and the data presented in FIG. 6C and both differences are the result of carbon deposition at the back end of the tube. The first difference is that in FIG. 7A, the maximum temperatures reached at both ends of the tube are similar, about 3.1° C. above the baseline. On the other hand, in FIG. 6C, in which no carbon was deposited at the far end of the tube, the maximum temperature at that end was 1.2° C. lower than at the front end of the tube. The second difference is that in FIG. 7A the maximum temperature at the front end of the tube was reached about 60 seconds before the maximum temperature was reached at the back end of the tube. On the other hand, FIG. 6C shows that the temperatures at the front end and back end of the tubes increased and decreased at nearly the same times. The results for FIG. 7B are similar. In this case, there is a sharp rise in temperature at the front end of the tube when the O₃ flow is started and there is a localized area about two inches in length that is measurably hotter than the rest of the tube length. Then after about a minute, the temperature at the far end of the tube increases and reaches a temperature that is 0.25° C. lower than the maximum temperature obtained at the front end of the tube. The data obtained in these tests are consistent with the oxidation of most of the carbon initially occurring at a point where O₃ first contacts the deposited carbon layer, causing a rapid rise in temperature at the front end of the tube and a somewhat slower temperature increase at the back end of the tube. As the process continues, the carbon layer at the front is consumed, reducing the heat generation there and resulting in a temperature decrease at that location. However, because more O₃ is now available at the back end of the tube, the oxidation rate of the carbon deposited at the exit then increases, causing a temperature maximum to occur at the back end of the tube.

Overall these experiments demonstrate the fundamental feasibility of this method and the effectiveness of the data reduction routine. In addition, these results show the method may quickly identify locations that contain carbon deposited in the flow path, as well as showing that the carbon deposits have been removed.

Multi-Channel Plate (MCP) Test Section

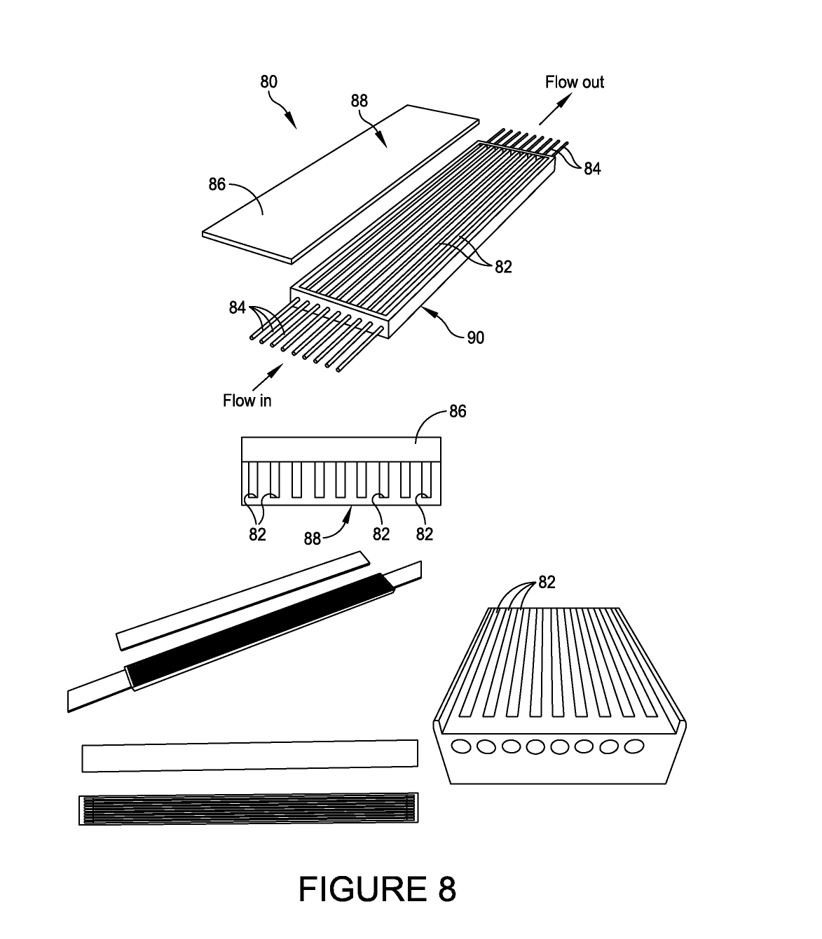

Referring now to FIG. 8, there is a multichannel test article or multi-channel plate (MCP) 80 to demonstrate the feasibility of a coke oxidation method in a more realistic geometry than a simple tube. Test article 80 and completed components before brazing are shown in FIG. 8. Test article 80 is 12 inches (29.4 cm) in length and contains nine channels 82 with dimensions consistent with those common in a liquid hydrocarbon-fueled rocket engine. Channels 82 are 0.05 inches (0.127 cm) wide and 0.15 inches (0.381 cm) in height with a 0.035 inch (0.089 cm) thick face sheet and a ⅛ inch thick back plate. This results in approximately twice as much copper volume to surface area ratio as for the simple tubular test section, therefore reducing our detection sensitivity by about a factor of two. The nine separate channels 82 are all connected to individual 1/16 inch (0.15875 inch) outer diameter copper tubes 84 attached to each end of the test article 80, providing the flexibility to vary the flow in each channel 82 or manifold the tubes 84 together so that the same flow is produced through each of the channels 82.

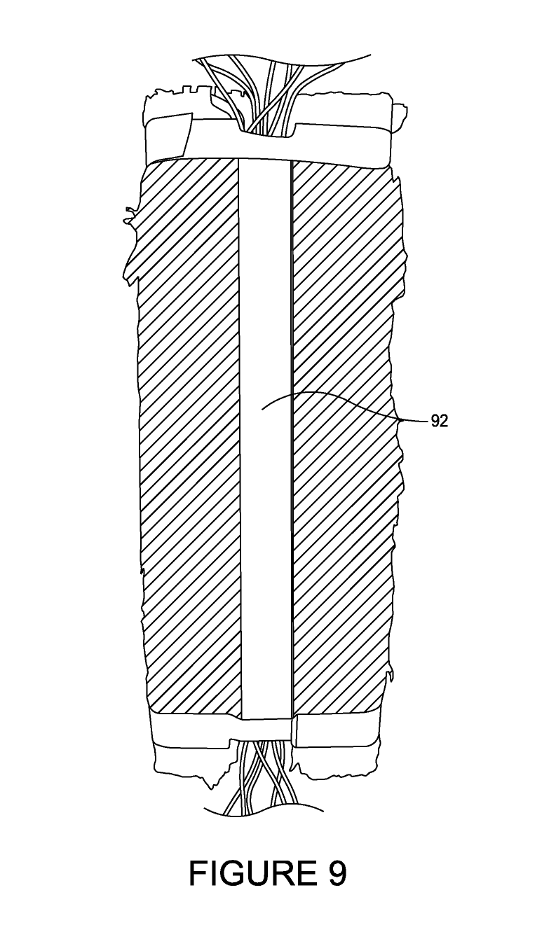

During the low temperature oxidation runs, heat was applied with a flat electric heater that was attached to the back side of the MCP 80. The front side 86 of the multichannel plate 80, which has a thickness of 0.035″ (0.9 mm) to simulate the thrust chamber liner, faced the thermal imaging camera as shown in FIG. 9. As with the copper tubes, the emissivity of the front surface was increased by applying a coat of high temperature flat black paint to the surface 88. This is actually quite similar to the expected condition of a used rocket engine due to the presence of a layer of soot on the inner surface of the rocket engine deposited by the fuel-rich film cooling technique employed at that location. The heater on the back side 90 allows front side surface to obtain temperatures that were relatively even over the length of the plate and ranged from 100 and 150° C. The following data reduction routine was implemented to improve the visualization of the thermal images of these tests. Rather than average the data across the width of the plate (since we were looking for channel-to-channel temperature variations and not just axial variations), all the temperatures measured across the plate surface were extracted during the oxidation run and the subsequent baseline run at a rate of one frame per second. The heat released was corrected from the ozone generator heating and O₃ surface/bulk fluid decomposition by subtracting the baseline temperatures from those recorded in the initial oxidation step at identical run times. Specific frames showing the decoking minus blank run temperature differences as a function of time, both before and after the O₃ flow was initiated, were then selected. Although this method of data reduction does not provide a continuous display of temperature difference as a function of time as was the case for the ¼″-tube (.0.635), it does show clearly where the temperature increase occurs during the oxidation run, which in turn shows where the carbon source is located. Moreover, since we obtain data every second, we could carry out the same analysis at much shorter time intervals.

In the first test we carried out on the MCP 80 to verify the heating and data reduction routine, an oxidation test was performed on the unit 80 without intentionally adding carbon to any of the channels in the plate. Therefore, the state of the test article was effectively “as received” from the machining and brazing processes. In this test, O₂ was flowed at a rate of 3 standard liters per minute (slpm) through eight of the nine channels 82 in the plate 80 (although there are nine channels on the plate, space limitations prevented inclusion of all nine channels 82 in the flow manifolds).

FIG. 9 illustrates a multi-channel plate test section mounted on the test apparatus.

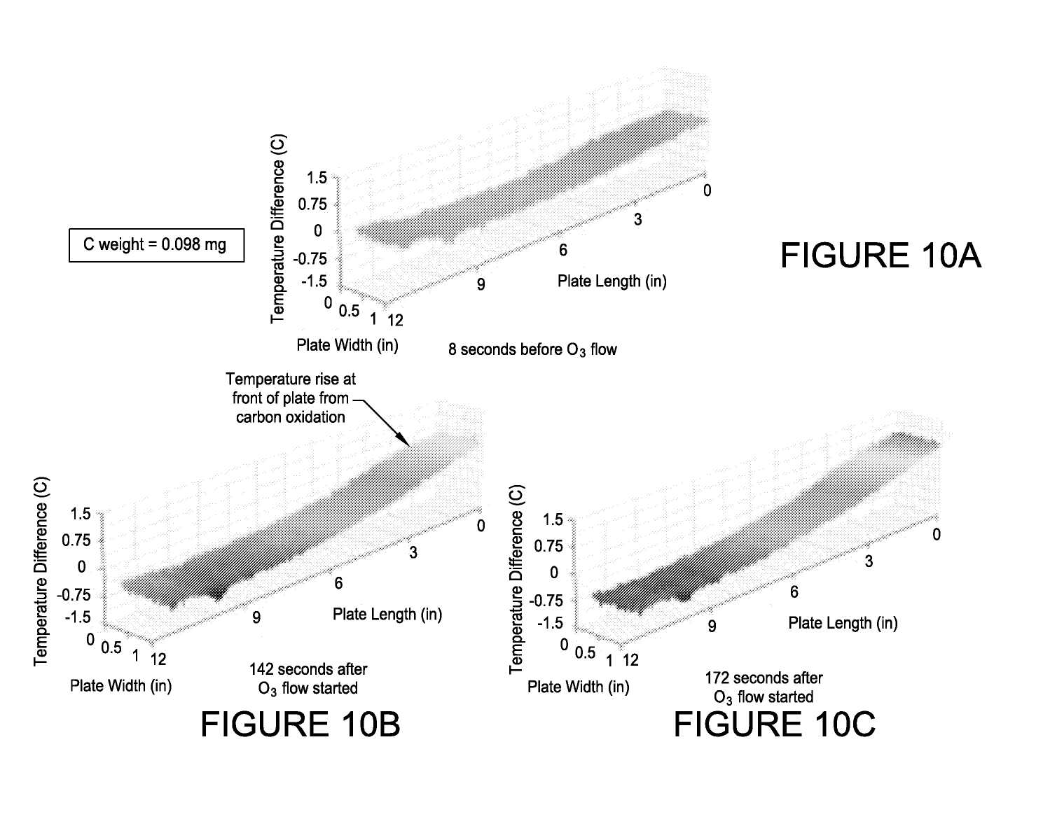

The resulting temperature differences at three different times are plotted in FIGS. 10A-10C, which shows temperature difference as a function of location on the surface of the plate. On the top of FIG. 10A, data was obtained eight seconds before the O₃ flow was started. FIG. 10A shows that at the front end (plate distance=0) where the flow was entering, the temperatures measured during the oxidation run were about 0.2° C. higher than they were during the baseline run, while at the back end of the plate (plate distance=12 inches or 30.48 cm) the temperatures were about 0.3° C. lower during the oxidation than in the baseline run. Data taken at other times before O₃ flow was started show that the temperatures were stable during this period. However, the data obtained after the O₃ was started (FIGS. 10B AND 10C) showed quite different behaviors between the initial oxidation run and the baseline run. After O₃ had been flowing for 142 seconds (FIG. 10B) the temperature differences at the front of the plate have increased from 0.2 to 0.6° C. indicating that the temperature during the first oxidation test increased by 0.4° C. more than it did in the baseline run. After O₃ had been flowing for 172 seconds (FIG. 100) the temperatures at the front of the plate were 0.75° C. higher during the oxidation step than they were during the subsequent baseline run after all of the carbon was oxidized. Thus, the net temperature increase from CO₂ production at the front end of the plate was 0.55° C. (0.75° C.-0.2° C.).

The CO₂ produced was monitored during each test. During the initial oxidation, a measurable CO₂ peak was obtained indicating that 0.098 mg of carbon had been oxidized, while during the subsequent baseline test we did not obtain any detectable level of CO₂. Since any carbon was not intentionally added to the plate before this test, it was concluded that there was probably some carbon-containing material introduced into the plate during or after the face machining process and that the oxidation of this material probably caused the temperature increase at the front of the plate. On the other hand, since there was no measurable rise in the temperature at the back end of the plate, we conclude that no carbon-containing compound was located in this part of the plate.

After completion of this test, a series of tests were carried out to characterize the O₃ lifetime in the plate after the carbon had been removed and found that a flow of about 2.5 slpm was required through each channel to prevent excessive O₃ loss. Therefore, in subsequent tests, we increased the overall O₂ flow to 10 slpm (the maximum flow for our mass flow controller) and only flowed O₂ through a maximum of four channels during the oxidation step. While in a full scale system all channels would be oxidized together, the only effect this modification had was to reduce the sensitivity of our method.

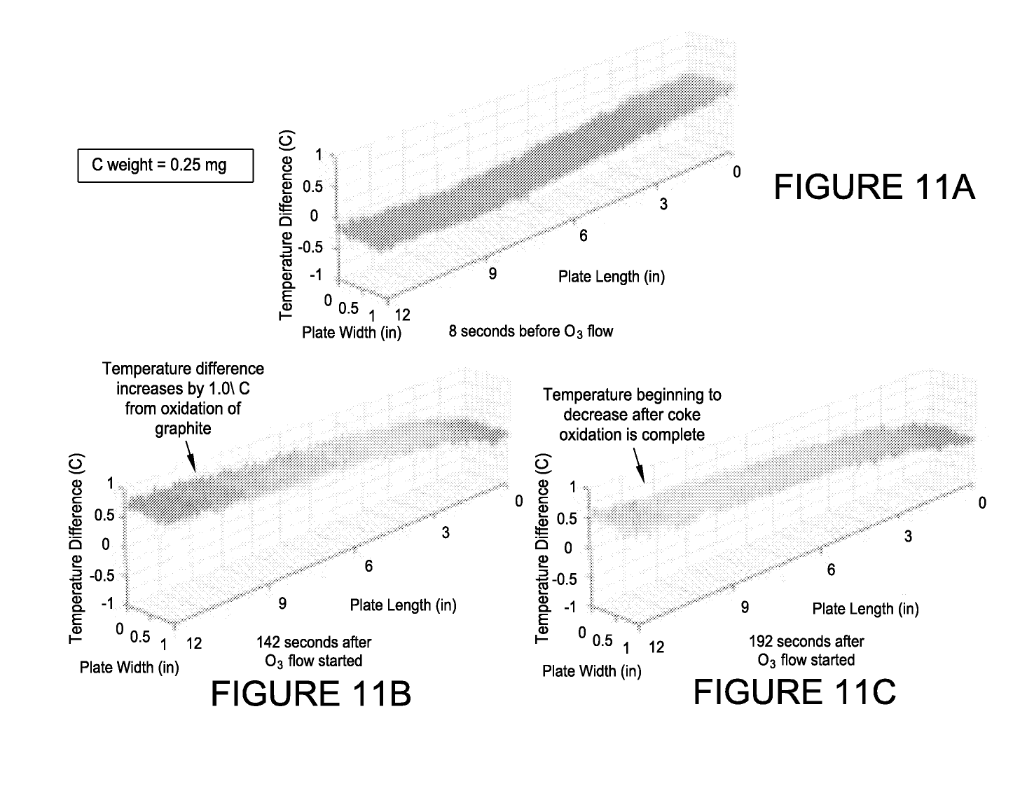

For the next decoking test, carbon was deposited in two of the channels using graphite paint. To accomplish this the paint solution was diluted by a factor of 10 with acetone, resulting in a concentration of 1.5 mg graphite/ml solution. Then, approximately 0.2 ml of solution was injected into two of the channels in the plate, channels 4 and 6 (the two channels next to center channel) and flowed air through the channels until the acetone was completely evaporated. The total carbon weight added was 0.3 mg. In FIGS. 11A-11C, the temperature differences are shown after the baseline temperatures were subtracted from those obtained during oxidation at three different times. On the top of FIG. 11A, eight seconds before the O₃ was started the temperatures measured at the front end during the oxidation run were about 0.5° C. higher than they were during the subsequent baseline run, while at the back end of the plate the temperatures were about 0.25° C. lower before oxidation than in the baseline. After O₃ had been flowing for 142 seconds (FIG. 11B) the temperatures measured at the back of the plate were 0.75° C. higher during the oxidation run than they were during the subsequent baseline run. Therefore, the temperature differences at the back end increased from −0.25° C. before the O₃ flow was started to +0.75° C. This net change of 1.0° C. reflects the temperature increase in the plate due to the heat produced from the oxidation of the carbon. At 192 seconds after the O₃ flow was started, (FIG. 11C) the temperature difference was starting to decrease, indicating that the combustion of the graphite was complete. Thus, the oxidation was completed in a time of approximately 192 seconds, in agreement with the CO₂ concentration measured with the on line analyzer during this test.

In this figure, the temperature rise occurs primarily at the back end of the plate, indicating that the graphite was deposited in this end of the plate. In FIG. 10A-10C, the data showed that the temperature increase occurred at the front end of the plate. FIGS. 10A-10C and 11A-11C indicate that the plate can heat up at either the front or back end depending on where the carbon is located and that there is no systematic experimental artifact that causes the plate to heat up preferentially at one end or the other.

The CO₂ signal was integrated during the test and calculated so that it corresponded to the oxidation of 0.25 mg of carbon. This agrees well with the theoretical quantity of 0.3 mg initially deposited in the MCP. The thermal data show that the coke was located on the back half of the test section, therefore the average thickness of the graphite layer was approximately 2 microinches. Finally, FIGS. 11A-11C show that there is no measurable variation in the plate temperature across the one inch width of the plate. This is due to the high thermal conductivity of copper which tends to smear out the local temperature rise. However there is a substantial difference between the front three inches and the back nine inches of the plate. As a result, the spatial resolution of this method is currently about 3 inches.

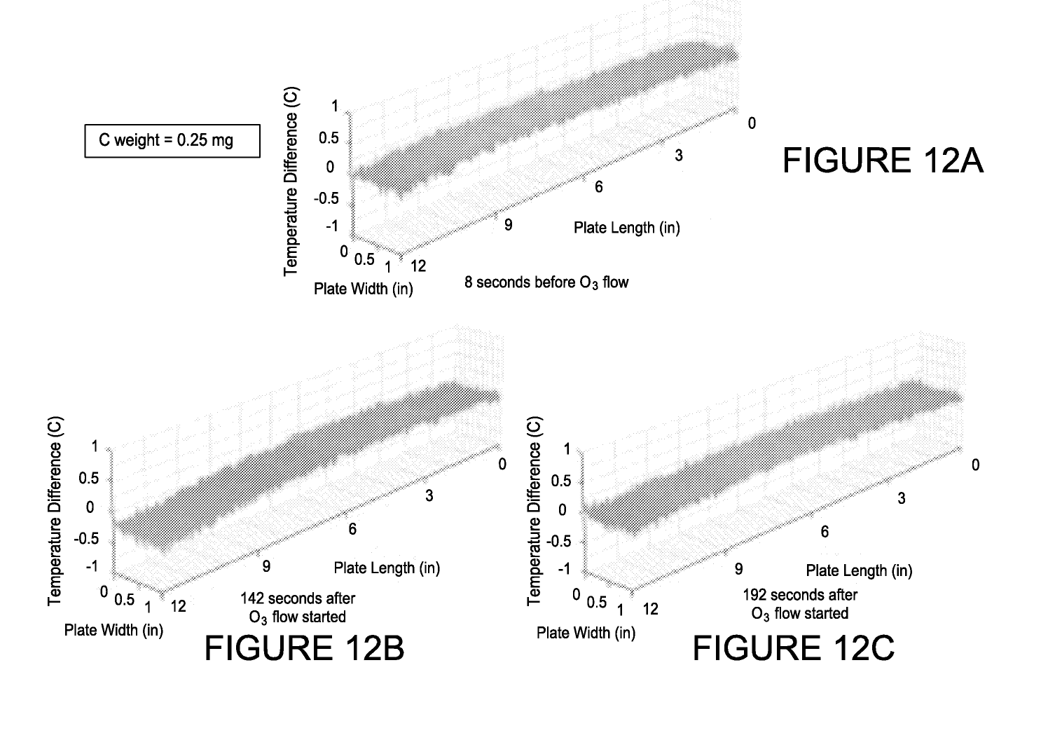

A second baseline run was carried out immediately after the first baseline in order to test the accuracy of our method. Since all of the carbon in the plate had been oxidized in the oxidation step, no carbon oxidation should be occurring in either the first or second baseline runs and therefore the temperature differences between the two runs should not show a change on one end as we saw previously in FIGS. 10A-10C and FIGS. 11A-11C. The temperature differences obtained by subtracting the temperature values of the second baseline run from the first baseline are shown in FIGS. 12A-12C, indicating that indeed this is the case. The figure shows that there is very little change in the profiles after the initial O₃ treatment, indicating that the differences we observed in the previous figures are the result of oxidation of carbonaceous materials inside the plate.

After showing that detection of the oxidation of very thin layers of carbon in the multichannel plate, three tests were carried out in which we coked the inside of the multichannel test section with the new provisional RP-2 fuel. Heat was provided by heaters attached to both the front and back of the test section and the entire assembly was enclosed in mineral wool insulation. In all three tests, the test section was maintained at 28.2 atm (400 psig) and the front and back of the plate to 550° C. was heated as RP-2 was flowed through the channels at a rate of 1.0 ml/min. Overall, a cracking level of about 1% was obtained during this coking run.

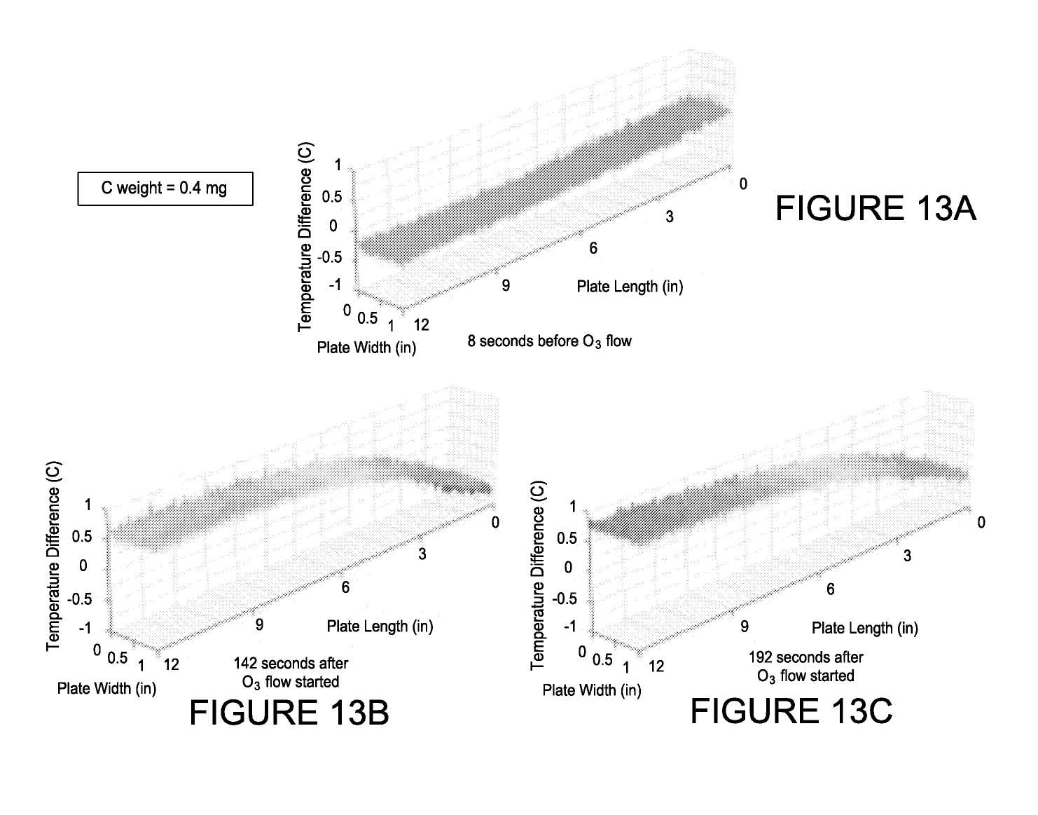

The temperatures differences obtained by subtracting the baseline temperatures from those obtained during oxidation are shown in FIGS. 13A-13C. FIGS. 13B and 13C show that the temperature differences at the back end of the plate rise substantially after the O₃ flow was initiated. In this case, the temperature difference rises from −0.2° C. to +0.7° C. or by approximately 0.9° C. only 142 seconds after the O₃ flow has been initiated. After an additional 50 seconds, the temperature difference has increased to +0.8 for a net change of 1.0° C. Once again this shows that the plate temperature increased by 1.0° C. more during the oxidation step than it did during the baseline test and this temperature rise was from the oxidation of coke. Integrating the CO₂ data resulted in a value of 0.4 mg of carbon oxidized. In addition, the thermal data show that the coke was deposited over the back half of the plate and therefore we conclude that the average coke thickness was approximately 1×10⁻⁶ inches (one millionth of an inch or 0.0254 microns.) The very similar behavior seen with both graphite paint in FIGS. 11A-11C and RP-2 coke deposits in FIGS. 13A-13C suggests that the carbon oxidation rate is not very sensitive to the exact nature and composition of the coke.

Full Scale Decoking System Design

The Phase I results showed that our coke mapping and removal approach is very effective on laboratory scale hardware. To be of practical value, however, application to a full scale rocket engine may be made without excessive cost or effort. Perhaps the most challenging aspect is warming the hardware to temperatures between 150 to 200° C. where the low temperature oxidation process can occur. This step may be done rapidly to meet short turnaround times. An engineering analysis estimates the heating requirements and thermal response times of an engine. An assembly including a blower and a portable gas-fired heater, equivalent to the size of an outdoor gas grill, produces the necessary temperature in an engine in about 15 minutes and consumes only about five pounds of propane.

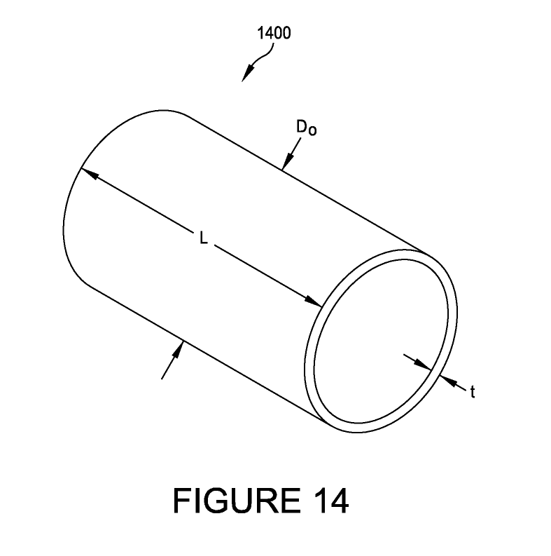

Rocket engines can be fairly massive objects, particularly those engines used as main propulsion on a space launch vehicle. Typical booster engine thrust levels are on the order of 300,000 to 1,000,000 pounds (136,000 to 454,000 kg.) Thrust-to-weight ratios of high performance engines are generally on the order of 100:1. An engine with a thrust of 750,000 lb_{f} (340,194.3 kg_{f}) would therefore weigh approximately 7500 lbₘ (3401.9 kgₘ). About ¼ of this weight is typically found in the thrust chamber and the regeneratively cooled section of the nozzle, which is where the fuel cooled passages that are prone to coking are located. Without knowing the specifics of an engine geometry, for the purposes of this heat transfer analysis the thrust chamber mass can be roughly assumed to be distributed as a simple annulus 1400, having a length L, a diameter Dₒ, and a wall thickness t, as shown in FIG. 14.

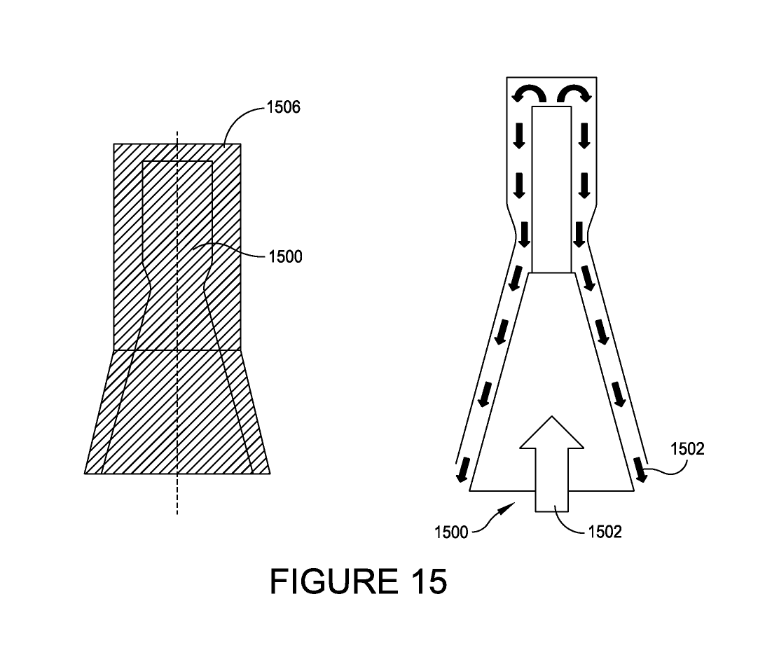

Using a full-scale engine cooled length of 70 inches (177.8 cm) and a thrust chamber wall thickness of 1 inch (2.54 cm) with an average diameter of 25 inches (63.5) yields an approximate mass of ˜1800 pounds (816.5 kg) of copper and nickel that would need to be heated for a decoking cycle. Using a specific heat of 0.093 Btu/Ibₘ-° F. (388 J/kg-° C.) for copper results in a total thrust chamber thermal capacitance mC of 175 Btu/° F. (332 kJ/° C.). This requires a minimum of 49,000 Btu's (51,650 kJ) to raise the temperature of the thrust chamber from 21 to 175° C. (where ozone oxidation of carbon works well) without any heat losses. Heating should probably be done within about 15 minutes to allow rapid ground processing of a reusable vehicle, therefore requiring a minimum heat transfer rate of 200,000 Btu/hr (58.6 kW) to the thrust chamber. This is about the same as two home central air furnaces. Pure electrical heating for a thermal load this size would be both expensive and taxing of many electrical supply installations, especially with multiple engines on a single vehicle. Even the ideal minimum heat load therefore suggests that heating an engine 1500 from inside along heat path 1502 using something like a ‘flameless’ radiant heater or blower with a propane burner, as shown in FIG. 15, would be one good way to accomplish it quickly and inexpensively.

Once the engine has been raised to the desired decoking temperature, it may be maintained for a period of time while temperatures stabilize, as well as during coke removal and thermal imaging. One good way to accomplish this is to use an electrically heated insulating blanket or mantle 1506 wrapped around the outside of the engine, as shown in FIG. 15. The magnitude of the steady-state heat loss rate from an insulated engine can be estimated by assuming an external combined heat transfer coefficient of ˜4 Btu/ft²-hr-° F. [METRIC] on the surface of a 2-in thick insulating blanket (kᵢₙₛ˜0.06 Btu/ft-hr-° F.), yielding an estimated heat loss rate of about 1300 Watts at 175° C. over a surface area of about 44 ft² [METRIC]. Due to the proliferation of connections of pipes and other equipment on the engine, this figure is probably too low, but a steady-state electrical heating demand on the order of 5 kW might be reasonable, and is feasible. An installed insulated mantle electrical heating capacity of around 10 kW would therefore allow for both active temperature control and the capacity to help increase the heating rate of the engine during the 15 minute heatup period.

The engine may be modeled as a lumped thermal mass to estimate the size of the heater needed. Using convective heating and cooling to the inside and outside environments and a uniform internal temperature provided the governing linear, non-homogeneous ordinary differential equation (ODE):

$$\frac{d T}{d t} + \frac{{U}_{∞} {A}_{o} + {h}_{i} {A}_{i}}{mC} T = \frac{{\dot{q}}_{elec} + {h}_{i} {A}_{i} {T}_{gas} + {U}_{∞} {A}_{o} {T}_{∞}}{mC}$$

Where T is the temperature of the rocket engine, mC is the engine thermal capacitance, U_{∞} is the effective external loss heat transfer coefficient, Aₒ is the external surface area, hᵢ is the internal heat transfer coefficient, Aᵢ is the engine internal combustion chamber and cooled nozzle surface area, q_{elec} is the electrical heat input rate, T_{gas} is the temperature of the hot gas source used to heat the engine, and T_{∞} is the ambient temperature where the engine is being processed. This ODE may be used to immediately obtain some information about the heating process in the form of the time constant, τ:

$$τ = \frac{mC}{{U}_{∞} {A}_{o} + {h}_{i} {A}_{i}}$$

Using an effective external loss heat transfer coefficient of 1.4 Btu/ft²-hr-° F., an external surface area of 44 ft², and an internal heat transfer coefficient of ˜20 Btu/ft²-hr-° F. (i.e., turbulent air convection) with a surface area of ˜35 ft² gives a time constant of about 14 minutes, which is actually surprisingly short. The values in the denominator indicate that this is mostly controlled by the convective heating process inside of the engine. The simple closed-form solution to the above ODE is:

$$\frac{{T}_{eq} - T ( t )}{{T}_{eq} - {T}_{0}} = exp ( - \frac{t}{τ} )$$

Where T(t) is the thrust chamber temperature at time t, t/t is the non-dimensional time, and T_{eq} is the equilibrium engine temperature attained if the heating process were continued over many time constants (>4). This equilibrium temperature is given by:

$${T}_{eq} = \frac{{\dot{q}}_{elec} + {U}_{∞} {A}_{o} {T}_{∞} + {h}_{i} {A}_{i} {T}_{gas}}{{U}_{∞} {A}_{o} + {h}_{i} {A}_{i}}$$

The closed form solution can be easily inverted to determine the average internal engine gas temperature required to meet the 15 minute heating goal to 175° C., yielding T_{eq}=253° C. and T_{gas}=247° C. (assuming a 10 kW total electrical heat input rate). This average gas temperature would seem to be reasonable, and not likely to overheat the hardware, and it should also allow volatilization and driving out any trapped fuel from the engine cooling passages during heating. This solution corresponds to an initial hardware heat input rate of 304,000 Btu/hr (89.0 kW) that could be satisfied with a low pressure rise air blower of about 500 cfm (14150 slpm) capacity (i.e., ˜¼ horsepower (0.19 kW)), and a total propane flow of about 5 pounds (2.3 kg) to accomplish the heating of a single engine.

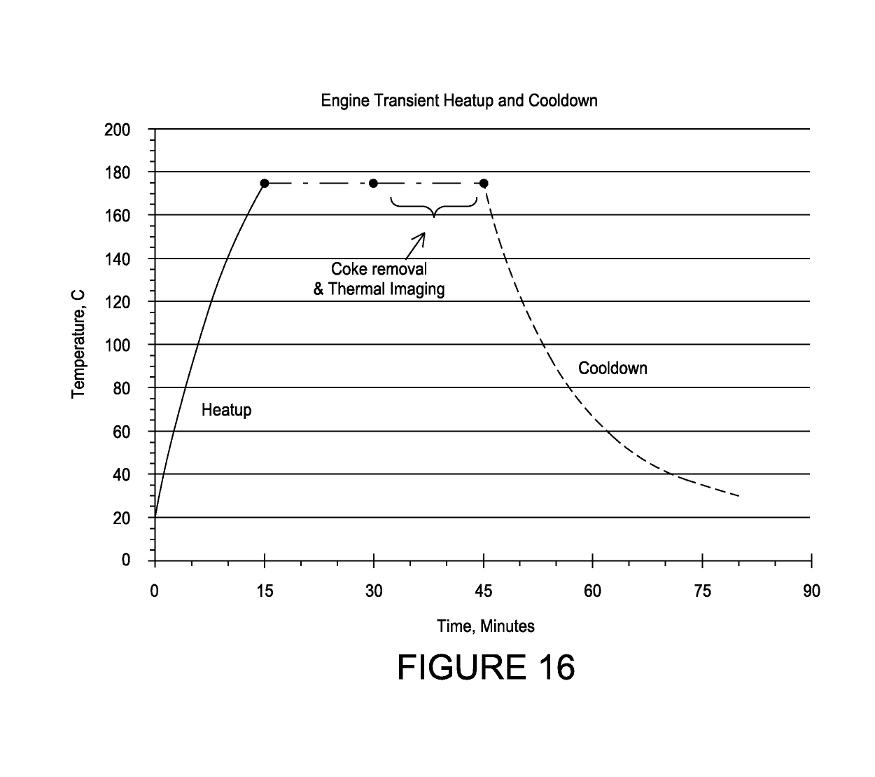

This analysis therefore indicates that it would be feasible to heat an engine in 15 minutes, allow its temperature to stabilize over the next 15 minutes, perform the ozone decoking and coke mapping over the next 15 minutes under constant input power, then remove the external heating blanket and allow the engine to cool while continuing to circulate cool air inside with the blower, as indicated in FIG. 16. The decreased time constant of about 12 minutes obtained with the external insulating blanket removed should drop the engine temperature to about 50° C. within 20 minutes after the beginning of the cooldown (when the hardware will be safe to touch) and down to 30° C. after 35 minutes (21° C. ambient). This stacks up to a total engine processing time of just 65 minutes before it is cool enough to be touch-safe, which is far smaller than the desired vehicle turnaround time of 8 hours. Moreover, this procedure can be accomplished with a system that is relatively small, about the size of an outdoor gas grill, portable, and inexpensive. The rocket engine heating may be accomplished as required to remove coke within the time available for ground processing.

The total quantity of carbon present can be calculated by monitoring the CO₂ concentration in the effluent during ozone oxidation. Even with the thin carbon layers deposited, online analyzers like the California Analytical NDIR CO₂ have adequate sensitivity to provide the continual measure of total coke oxidation rate. A coke thickness of 1.0×10⁻⁶ inches was calculated above with 2.26×10⁻⁶ grams or 1.88×10⁻⁷ moles carbon in a 1 cm (0.39-in) length of a single channel. If a similar thickness is assumed through the entire cooling channel flow path, 60 inches long and 400 cooling channels, the total quantity of coke is estimated to be 0.138 grams of carbon or 0.0114 gram moles. When oxidized, 0.0114 moles of carbon will produce a total volume of 0.276 standard liters of CO₂. The total flow area in all channels is 19.2 cm² (0.048 cm² per channel×400 channels) and therefore if the total gaseous flow rate is 5 slpm, the velocity through the channels is 258 cm/min (102 in/min) resulting in a residence time of less than a minute, which will provide an accurate picture of the amount of carbon present in the cooling channels. Finally, if all of the carbon is assumed to be oxidized to CO₂ in a period of 15 min, the average CO₂ concentration will be about 0.37%. Online analyzers are available with detection limits of 0.0001% or 1 ppm, so concentrations of 0.37% (3700 ppmv) can be readily detected.

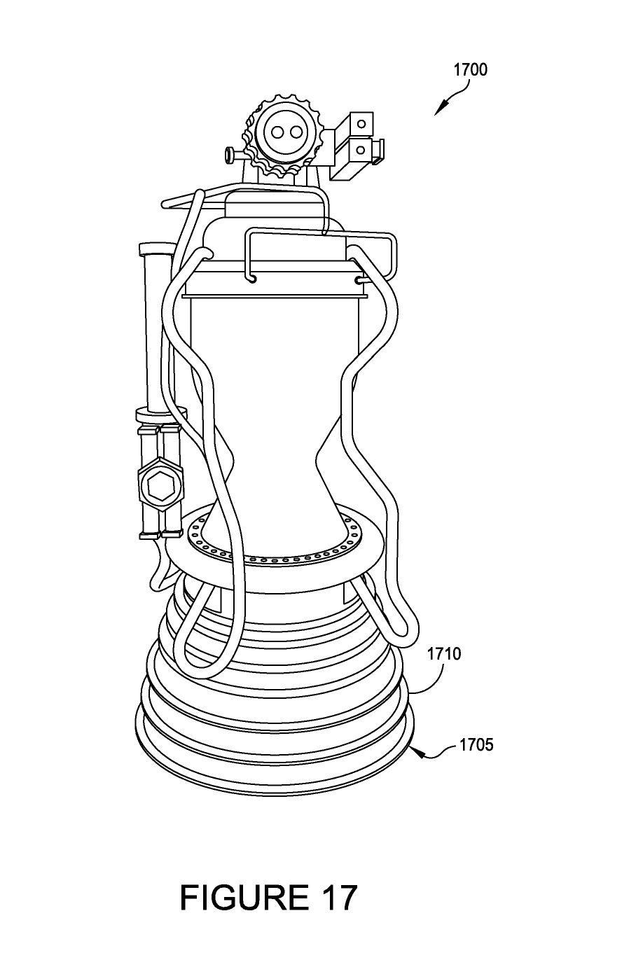

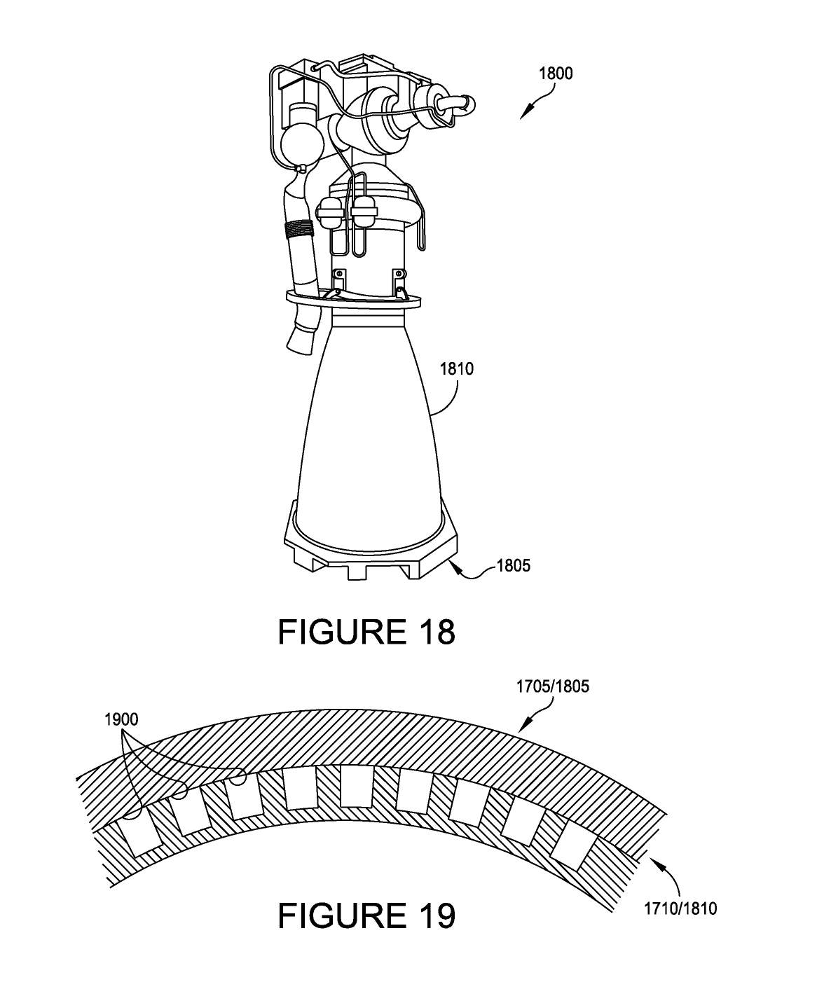

FIGS. 17 and 18 illustrate typical rocket engines 1700 and 1800, respectively. At a base portion 1705 of each rocket engine 1700 and 1800, is a set of fuel cooling channels 1900 (see FIG. 19) machined in the walls 1710, 1810 of rocket engines 1700, 1800, respectively.

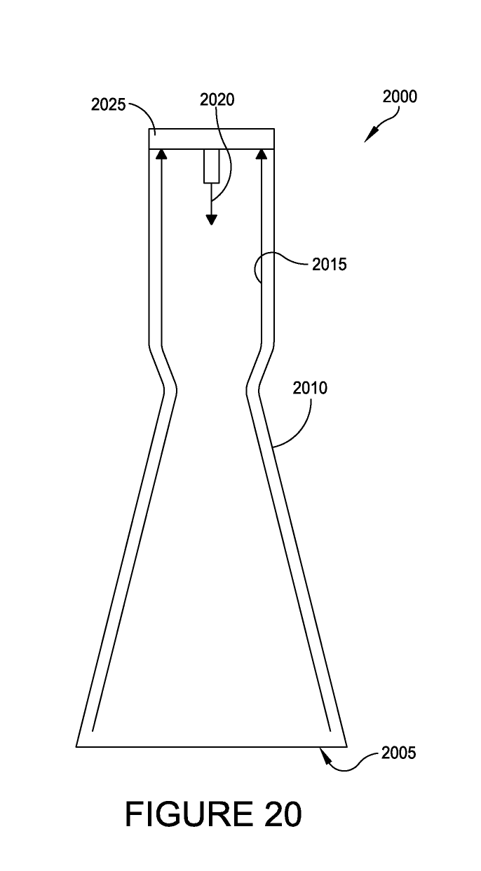

FIG. 20 illustrates an exemplary embodiment of a rocket engine 2020 (which may be similar to rocket engines 1700, 1800) with a cleansing ozone flow 2015 through channels in wall 2010 and a exit ozone flow 2010 from manifold 2025. In another embodiment, not shown, the flow could be reversed through manifold 2025 prior to flow through the channels in wall 2010.

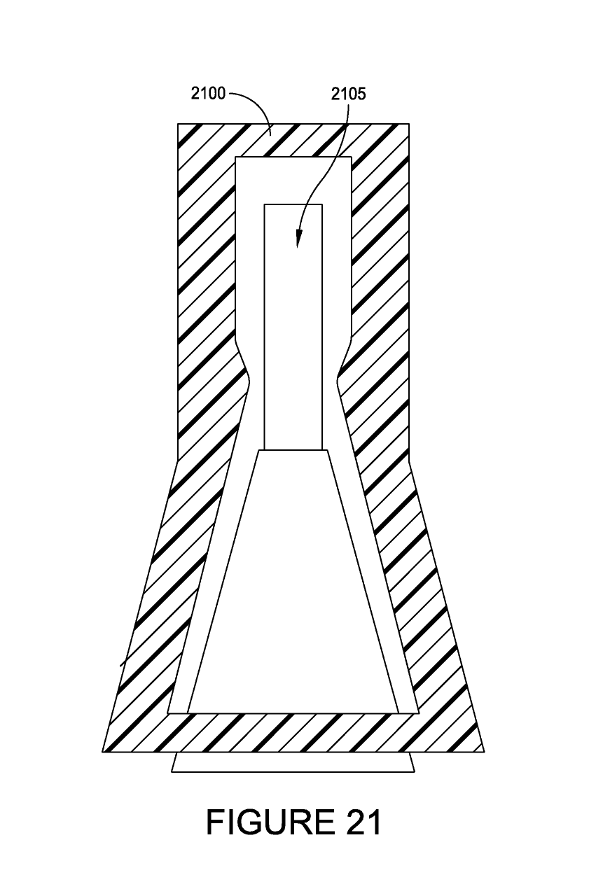

FIG. 21 illustrates an embodiment of an electrical heating mantle and insulating jacket 2100 on the outside of a rocket engine 2105.

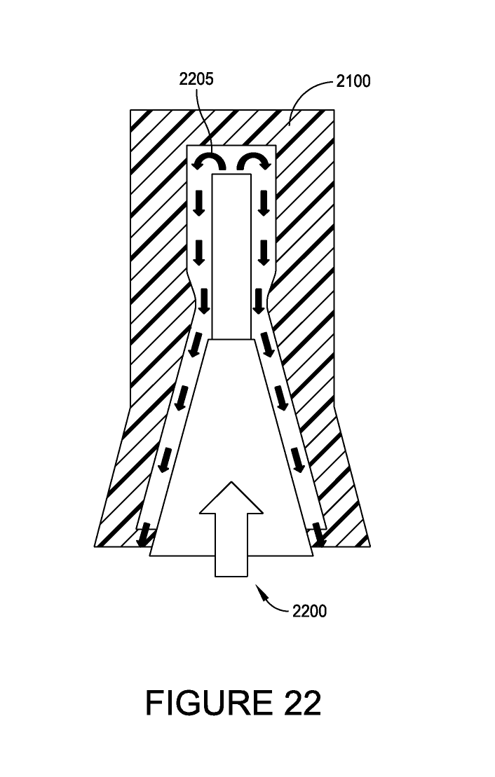

FIG. 22 illustrates a propane burner 2200 providing heat flow 2205 through rocket engine 2100 within heating jacket 2100 (illustrated in FIG. 21.)

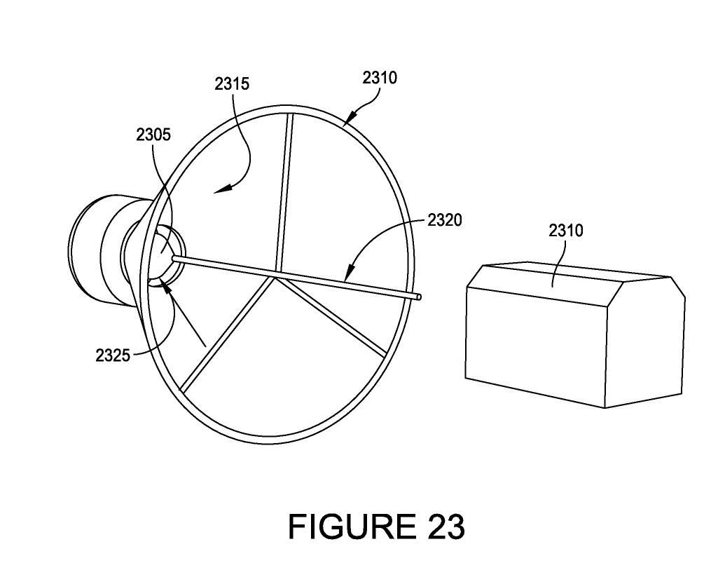

FIG. 23 illustrates an arrangement of a camera 2300 and a mirror 2305 for thermal imaging of a rocket engine 2310. Thermal imaging of heat transfer surfaces may include directing thermal camera 2300 toward an interior region 2315 of rocket engine 2310 so as to image heat transfer surfaces 2315 of the rocket engine 2310. A mirror guide 2320 may be disposed within interior region 2315 of rocket engine 2310. Mirror 2305 may be selectively moveable along mirror guide 2320. An actuator 2325 may be provided to reposition mirror 2305 along mirror guide 2320 at selected distances from thermal camera 2310 so as to image heat transfer surfaces 2315 of rocket engine 2310. For example, the speed of the movement of the mirror may be used to calculate the distance of the camera from the mirror. This can be used to correlate a particular frame recorded by the camera with a particular location of the heat transfer surface of the rocket engine.

Kinetics of Coke Oxidation

Previous work (Wickham, D. T., Engel, J. R., Jones, M. and Windecker, B., “Methods to Remove Coke from Endothermic Heat Exchangers,” NASA Phase II Final Report, Contract No. NNCO5CAO5C (2007)) showed that the rate of coke oxidation at temperatures between 100 and 200° C. was very rapid, even with layers approaching thicknesses of thousandths of an inch. In most cases the oxidation was complete in periods of several minutes. Thus, the CO₂ concentrations in the effluent will be higher than those estimated above. In addition, it is possible that the rate of coke oxidation will be determined by the flux of O₃ to the carbon surface. At a velocity of 258 cm/min, and with an O₃ concentration of 0.5%, mass transfer calculations show that all the O₃ contained in the flow will contact the surface layers of carbon within a distance of several centimeters and, therefore, it is possible that all of the O₃ would be consumed in a relatively short distance. In this case, a temperature increase would be measured only in the first part of the flow path. However, as the carbon in that section is consumed, more O₃ is available for the next portion of the reactor so that an oxidation front moves down the length of the cooling channels. With scan rates of up to 60 Hz, the FLIR SC325 can easily capture this movement of the oxidation front. In this case, the concentration of CO₂ exiting the manifold is determined by the reaction stoichiometry shown in Eq. 1 and the O₃ concentration entering the manifold. Moreover, the thickness of the layer at any position can be determined by the magnitude and duration of localized temperature increases. Once the IR camera shows that the oxidation front has reached the end of the flow path, the production of CO₂ stops.

Hazard Mitigation

Our coke mapping and removal process can be carried out very safely because the two potential hazards: 1) introducing an oxidizing agent into the fuel cooling channels, and 2) exposure to O₃, can be effectively mitigated. To prevent hazards associated with flowing O₃ or O₂ through the cooling channels, the first step in the process is to flush the channels with N₂ at ambient temperature removing any liquid fuel left in the heat exchanger. A purge is continued as a heater is then used to raise the heat exchanger temperature to about 175° C., which will vaporize the last residuals of fuel. Moreover, when low concentrations of O₂ and O₃ are introduced, the system will be operating at atmospheric pressure and the quantities of coke are small enough that very little temperature rise can occur from the oxidation process. Finally, after the process has been completed the fuel channels can again flushed with N₂ to remove any traces of O₂ before the vehicle is refueled.

Hazards associated with O₃ exposure are prevented by several factors. First, the 0.1 to 0.5% O₃ levels used are generated as needed by directing an O₂ flow through an online O₃ generator, eliminating any requirement to store or handle O₃. Next, while O₃ is flowing through the channels, all flows exiting the manifold are directed through a commercial O₃ decomposition catalyst before it is vented to atmosphere. The catalyst modules are 99.9% efficient and cost less than $50/unit. (Absolute Ozone, accessed at http://www.ozonesolutions.com/products/Ozone-Destruct-Units/ODS-3_High_Flow_Ozone_Destruct_Unit, 2011) If the concentration exiting the heat exchanger is 0.15% using two catalyst beds in series would produce a concentration 0.0015 ppm, a factor of 66 less than the 0.1 ppm OSHA 8 hour PEL. (Occupational Safety and Health Administration, “Limits for Air Contaminants,” Code of Federal Regulations 29 CFR 1910, Subpart Z, Table Z-1. Accessed at: http://www.osha.gov/pls/oshaweb/owadisp.show_document?p_table=STANDARD S&p_id=9992) Moreover, once the flow is diluted in the atmosphere the concentrations will be even lower. O₃ has been used without incident in a number of projects, including the development of methods to oxidize coke deposits in endothermic heat exchangers and to control waste streams produced in space missions.

Advantages of this Technology

The low temperature oxidation approach has a number of advantages over other potential methods to map coke deposition. First of all, it is a rapid, non-intrusive way to characterize coke deposition over the entire cooling channel assembly. It provides accurate, reliable data to be obtained that then allows engine life prediction models to be generated and to determine required service intervals. It can be done quickly while the engine is still on the vehicle. Finally, it is a safe and simple method that does not require handling or storage of any hazardous chemicals. The gentle, low temperature oxidation process allowed by the use of ozone results in nearly zero oxidation of the underlying metal. While coke removal can also be done with oxygen, the high temperatures required (>500° C.) can cause significant oxidative attack on the metal as well as warpage and destruction of elastomers.

In addition to all of the attractive features outlined above, this method has another significant advantage. In the process of mapping the coke deposition, it completely removes all of the coke from the heat exchanger pathways. Therefore, it solves the difficult and challenging problem of coke removal from a complex flow path. Moreover, the mapping process does not have to be employed every time coke is removed from the cooling channels. One scenario would be to carry out the imaging with coke oxidation at selected times, for example during engine development or when the engine has completed a specific number of missions. However, the low temperature ozone oxidation process could be used without the camera as a part of the routine maintenance between each mission, to remove any coke that accumulated during the previous mission. This would save time and reduce cost, but still allow the engine to be reused safely. In addition, the total quantity of coke removed in each treatment could be determined by attaching a CO₂ analyzer to the lines exiting the channels. Thus, there are several ways this technology could be employed to support the particular engine maintenance or development goals.

Alternative Ways to Make or Use this Technology

It is possible to operate the ozone coke removal process without employing the thermal camera for mapping of the deposit location. It may also be possible to identify another active oxidation compound that could fulfill the role of ozone in this invention. More active oxidizers could potentially lower the hardware preheating requirement, which would also improve the baseline hardware temperature stability and therefore improve the sensitivity of this method. Removing coke with oxygen is also possible, but requires temperatures on the order of 500° C. (932° F.) to accomplish. Many components cannot withstand temperatures this high due to the presence of elastomers, and significant oxidation of surfaces can occur along with dimensional changes or warpage.

Limitations

It is possible for the coke mapping process to not work if the coke layers are too thin or if the thermal mass and thermal conductivity of the thrust chamber is too large for the heat from coke oxidation to increase the temperature of the liner more that the Noise Equivalent Temperature Difference (NETD) of the thermal camera. Another limitation on detection level occurs if insufficient time is given for the rocket engine to approach a steady-state temperature distribution. While an engine does not need to be completely isothermal, engine heating transients must be allowed to decay before coke mapping can be accomplished. In addition, this steady-state temperature distribution must be maintained to the end of the second oxidation cycle in order to identify the small temperature differences associated with coke oxidation.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method of cleaning a liquid hydrocarbon-cooled bipropellant rocket engine, the method comprising:
heating the engine to a given temperature;
applying ozone to flow through channels in the engine wall for a period of time; and
determining the given temperature and the period of time are each sufficient to remove carbonaceous deposits from heat transfer surfaces of the liquid hydrocarbon-cooled bipropellant rocket engine.

2. The method of claim 1 wherein the step of heating the engine to the given temperature comprises the given temperature in a range from 150° C. to 200° C.

3. The method of claim 1 wherein the step of heating the engine to the given temperature comprises the given temperature in a range from 160° C. to 180° C.

4. The method of claim 1 wherein the step of applying ozone to flow through channels in the engine wall for a period of time comprises the period of time within a range of 10 to 60 minutes.

5. The method of claim 1 wherein the step of applying ozone to flow through channels in the engine wall for a period of time comprises the period of time within a range of 10 to 20 minutes.

6. The method of claim 1 wherein the step of applying ozone to flow through channels in the engine wall for a period of time comprises the period of time within a range of about 15 minutes.

7. The method of claim 1 wherein the step of determining the given temperature and the period of time are each sufficient to remove the carbonaceous deposits from heat transfer surfaces of the liquid hydrocarbon-cooled bipropellant rocket engine comprises maintaining the engine at the given temperature and flowing the ozone through the channels for the period of time based on a size of the engine.

8. The method of claim 1 wherein the step of determining the given temperature and the period of time are each sufficient to remove the carbonaceous deposits from heat transfer surfaces of the liquid hydrocarbon-cooled bipropellant rocket engine comprises maintaining the engine at the given temperature and flowing the ozone through the channels for the period of time based on a size of the engine.

9. The method of claim 1 wherein the step of determining the given temperature and the period of time are each sufficient to remove the carbonaceous deposits from heat transfer surfaces of the liquid hydrocarbon-cooled bipropellant rocket engine comprises maintaining the engine at the given temperature and flowing the ozone through the channels for the period of time based on thermal imaging of the heat transfer surfaces.

10. The method of claim 1 further comprising placing an insulating jacket on an outside surface of the rocket engine so as to maintain the engine at the given temperature.

11. The method of claim 1 further comprising placing an electric heating mantle on an outside surface of the rocket engine so as to maintain the engine at the given temperature.

12. The method of claim 1 further comprising placing an insulating jacket and an electric heating mantle on an outside surface of the rocket engine so as to maintain the engine at the given temperature.

13. The method of claim 11 further comprising placing a heating manifold insert within an interior region of the rocket engine so as to maintain the engine at the given temperature.

14. The method of claim 1 further comprising placing a heating manifold insert within an interior of the rocket engine so as to maintain the engine at the given temperature.

15. The method of claim 1 further comprising directing a path of heat flow from a propane burner within an interior of the rocket engine so as to maintain the engine at the given temperature.

16. The method of claim 1 further comprising purging the engine with nitrogen to remove fuel prior to applying ozone.

17. The method of claim 1 further comprising thermally imaging the heat transfer surfaces.

18. The method of claim 17 wherein the thermal imaging of the heat transfer surfaces includes directing a thermal camera toward an interior region of the rocket engine so as to image the heat transfer surfaces of the rocket engine.

19. The method of claim 18 wherein the thermal imaging of the heat transfer surfaces includes a mirror guide disposed within the interior region of the rocket engine, a mirror selectively moveable along the mirror guide, and an actuator to reposition the mirror along the mirror guide at different distances from the thermal camera with the thermal camera being directed toward an interior region of the rocket engine so as to image the heat transfer surfaces of the rocket engine.

20. The method of claim 19 further comprising processing a position of the mirror with respect to the mirror guide so as to determine a position of an imaged location of the heat transfer surfaces of the rocket engine.

21. A method of cleaning a liquid hydrocarbon-cooled bipropellant rocket engine, the method comprising:
heating the engine to a given temperature;
applying ozone to flow through channels in the engine wall for a period of time; and
thermally imaging the heat transfer surfaces to determine the given temperature and the period of time are each sufficient to remove carbonaceous deposits from heat transfer surfaces of the liquid hydrocarbon-cooled bipropellant rocket engine.

22. The method of claim 21 wherein the thermal imaging of the heat transfer surfaces includes directing a thermal camera toward an interior region of the rocket engine so as to image the heat transfer surfaces of the rocket engine.

23. The method of claim 22 wherein the thermal imaging of the heat transfer surfaces includes a mirror guide disposed within the interior region of the rocket engine, a mirror selectively moveable along the mirror guide, and an actuator to reposition the mirror along the mirror guide at different distances from the thermal camera with the thermal camera being directed toward an interior region of the rocket engine so as to image the heat transfer surfaces of the rocket engine.

24. The method of claim 23 further comprising processing a position of the mirror with respect to the mirror guide so as to determine a position of the thermal camera with respect to an imaged location on the heat transfer surfaces of the rocket engine.

25. The method of claim 23 further comprising purging the engine with nitrogen to remove fuel prior to applying ozone.

26. A method of cleaning a liquid hydrocarbon-cooled bipropellant rocket engine, the method comprising:
heating the engine to a given temperature;
applying ozone to flow through channels in the engine wall for a period of time; and
monitoring at least one of carbon dioxide and water emitted from the channels to determine the period of time are each sufficient to remove carbonaceous deposits from heat transfer surfaces of the liquid hydrocarbon-cooled bipropellant rocket engine.

27. The method of claim 26 further comprising monitoring infrared thermal imaging of the engine to determine the period of time are each sufficient to remove carbonaceous deposits from heat transfer surfaces of the liquid hydrocarbon-cooled bipropellant rocket engine.

28. The method of claim 26 further comprising purging the engine with nitrogen to remove fuel prior to applying ozone.

29. A method of cleaning a liquid hydrocarbon-cooled bipropellant rocket engine, the method comprising:
heating the engine to a given temperature;
applying ozone to flow through channels in the engine wall for a period of time; and
monitoring infrared thermal imaging of the engine to determine the period of time is sufficient to remove carbonaceous deposits from heat transfer surfaces of the liquid hydrocarbon-cooled bipropellant rocket engine.

30. The method of claim 29 further comprising monitoring carbon dioxide emitted from the channels to determine the period of time is sufficient to remove carbonaceous deposits from heat transfer surfaces of the liquid hydrocarbon-cooled bipropellant rocket engine.

31. The method of claim 29 further comprising mapping coke deposits based on the step of monitoring infrared thermal imaging to determine where the coke deposits are located in the channels in the engine wall.

32. The method of claim 29 further comprising purging the engine with nitrogen to remove fuel prior to applying ozone.

33. The method of claim 29 further comprising purging the engine with nitrogen to remove fuel prior to applying ozone.

34. Apparatus for cleaning a liquid hydrocarbon-cooled bipropellant rocket engine, the apparatus comprising:
a heater configured to heat the engine to a given temperature; and
an ozone source configured to apply a flow of ozone to channels in the engine wall for a period of time.

35. Apparatus according to claim 34 further comprising a thermal camera configured to thermally image the heat transfer surfaces to determine the given temperature and the period of time are each sufficient to remove carbonaceous deposits from heat transfer surfaces of the liquid hydrocarbon-cooled bipropellant rocket engine.

36. Apparatus according to claim 34 further comprising a carbon dioxide detector configured to monitor carbon dioxide emitted from the channels to determine the period of time are each sufficient to remove carbonaceous deposits from heat transfer surfaces of the liquid hydrocarbon-cooled bipropellant rocket engine.

37. Apparatus according to claim 34 further comprising a nitrogen source configured to purge the engine with nitrogen to remove fuel prior to applying ozone.

38. The apparatus of claim 34 wherein the thermal camera has a lens directed toward an interior region of the rocket engine so as to image the heat transfer surfaces of the rocket engine.

39. The apparatus of claim 38 further including a mirror guide disposed within the interior region of the rocket engine, a mirror selectively moveable along the mirror guide, and an actuator to reposition the mirror along the mirror guide at different distances from the thermal camera with the lens of the thermal camera being directed toward an interior region of the rocket engine so as to image the heat transfer surfaces of the rocket engine.

40. The apparatus of claim 39 further comprising a processor configured to receive a position of the mirror with respect to the mirror guide so as to determine a position of an imaged location of the heat transfer surfaces of the rocket engine.

41. The apparatus of claim 34 further comprising an insulating jacket configured to cover an outside surface of the rocket engine so as to maintain the engine at the given temperature.

42. The apparatus of claim 34 further comprising an electric heating mantle configured to cover an outside surface of the rocket engine so as to maintain the engine at the given temperature.

43. The apparatus of claim 34 further comprising an insulating jacket and an electric heating mantle configured to cover an outside surface of the rocket engine so as to maintain the engine at the given temperature.

44. The apparatus of claim 43 further comprising a heating manifold insert configured to position within an interior region of the rocket engine so as to maintain the engine at the given temperature.

45. The apparatus of claim 34 further comprising a heating manifold insert configured to position within an interior of the rocket engine so as to maintain the engine at the given temperature.

46. The apparatus of claim 34 further comprising a propane burner configured to direct a path of heat flow from within an interior of the rocket engine so as to maintain the engine at the given temperature.

47. The apparatus of claim 34 further comprising a source of nitrogen configured to purge the engine with the nitrogen to remove fuel prior to applying ozone.
